(19) United States
(12) Patent Application Publication
(10) Pub. No.: US 2026/0228681 A1
(43) Pub. Date: Aug. 6, 2026

(54) METHOD AND TRANSFER APPARATUS FOR TRANSFERRING COMMODITY OBJECTS

(71) Applicant: INNOVATIVE ROBOT DELIVERY GMBH, Bonn (DE)

(72) Inventors: Christof Schares, Bonn (DE); Boris Mayer, Bonn (DE); Christian Borger, Bonn (DE)

(21) Appl. No.: 18/705,495

(22) PCT Filed: Oct. 26, 2022
(86) PCT No.: PCT/EP2022/079926

§ 371 Date: Mar. 2, 2026

(30) Foreign Application Priority Data
Oct. 28, 2021 (DE) 10 2021 128 214.4

(51) Int. Cl. G06Q 10/0836

(52) U.S. Cl. CPC G06Q 10/08365

(57) ABSTRACT

The invention relates to a method for handover of a plurality of goods objects to a plurality of recipients, wherein the goods objects are stored and/or transported in parcels and are transferred in the parcels to a depot facility and then stored in the depot facility. According to the invention, the method is characterized in that, for at least some of the parcels, in each case at least one goods object located in the parcel is made available to a recipient for removal, so that a handover of the goods object is carried out as a first handover operation, but a handover of the parcel is prevented, so that the parcel which is not handed over to the recipient of the goods object remains in the depot facility, in that the parcel is filled with at least one further goods object after the first handover operation and is used for a further handover operation for the further goods object to a further recipient.
The invention also relates to a transfer device and logistics system suitable for carrying out the method.

### BACKGROUND

Systems are known in the state of the art which make it possible to deliver a large number of parcels to a large number of recipients or to receive parcels from a large number of shippers.

There is a great need to reduce the resulting ecological footprint.

Known solutions are aimed at improving transport and handover logistics, for example through the use of electronic parcel lockers, which are used to handover parcels.

Other known solutions are aimed at using reusable containers for parcel shipping. So far, these solutions have failed because it has not been possible to establish a closed cycle of reusable containers from shippers to recipients. This is where the invention described below comes in.

### SUMMARY

The invention is based on the task of providing a method and a handover device for the handover of goods objects, so that goods objects can be handed over with the smallest possible ecological footprint.

According to the invention, this task is solved by a method and a handover device for handover of parcels.

According to the invention, a method for handover of a plurality of goods objects to a plurality of recipients is provided, wherein the goods objects are stored and/or transported in parcels and transferred to a depot facility and then stored in the depot facility.

The invention is characterized in that, in at least some of the parcels, in each case at least one goods object contained in the parcel is made available to a recipient for removal, so that a handover of the goods object is carried out as a handover operation, but a handover of the parcel is prevented, so that the parcel which is not handed over to the recipient of the goods object remains in the depot facility, in that the parcel is filled with at least one further goods object after the handover operation and is used for a further handover operation for the further goods object to a further recipient.

A preferred embodiment of the invention provides for at least individual parcels to be loaded again with at least one further goods object within the depot facility after the goods object has been removed. In a particularly preferred further embodiment, the parcel loaded with the further goods object is used in the depot facility for a transfer process for the further parcel.

Forwarding at least a further part of the parcels without immediate refilling within the depot facility is also advantageous. In this case, the parcel is transported to a depositor of further goods objects and/or to a picking device. Conveniently, the parcels are filled again with goods objects after reaching the consignor or the order picking facility and delivered to the logistics system as new parcels.

Goods objects are physical objects that can be physically acted upon by the logistics system or a component of the logistics system and that are then physically accessed by another entity. The other entity can be a recipient of the goods objects or a physical device that is designed to exert physical influence in place of the recipient. In various embodiments of the invention, for example in embodiments of the depot facilities shown in this application as sales facilities, it is appropriate for the transfer of physical availability of the goods object to take place when the recipient has previously acquired the goods object. Objects of daily use such as consumables or foodstuffs as well as technical objects and equipment can be considered as goods objects.

Unless parcels are expressly called data parcels or virtual parcels in the present application, the parcels depicted in the present application are physical parcels. Parcels within the meaning of the invention are objects in which goods objects are stored and/or transported. Goods objects contained in individual parcels can be daily necessities such as consumables or food, as well as technical items and equipment. Preferably, several of the goods objects are unpackaged items, packaged items and repackaged items, wherein in the case of packaged and repackaged items, the parcel comprises the packaging or outer packaging and the item packaged therein. In at least some of the goods objects illustrated in this application, the goods objects are not parcels themselves, but are objects which are placed in parcels, wherein in a particularly preferred embodiment, some of the parcels are designed as reusable containers.

Accordingly, at least some of these parcels are designed so that the parcel itself is not a goods object, but that the parcel is designed in such a way that it constitutes an outer packaging for the goods objects and that the goods object can be removed from the parcel. These outer packagings, referred to as reusable containers, are parcels within the meaning of the application both with and without contents.

According to the invention, the problem underlying the invention is further solved in that a handover device for handing over goods objects contained in parcels is designed in such a way that, in the case of at least some of the parcels, at least one goods object contained in the parcel can be made available to a recipient for removal, so that a handover of the goods object can be carried out as a handover process, and in that the handover device contains a means which can prevent a handover of the parcel.

In particular, the handover device can be a handover gate or a handover unit. The arrangement of the transfer device in the area of the depot facility is particularly preferred.

The depot facilities illustrated in this application are preferably set up as mobile depot facilities. However, the invention is not limited to mobile depot facilities. Depot facilities within the meaning of the present invention are all devices which contain a means for storing the parcels, in particular within an intended handover period, and at least one means for handover of the parcels. These are preferably lockbox-type depot facilities which comprise a combination of secure, reliable storage of the parcels, protected from external influences, with a reliably automated handover device for handover of the parcels which responds to the recipient of a delivery request, in particular during an intended handover period. The storage of the parcels protected from external influences preferably includes preventing persons from accessing the parcels. The depot facilities thus include a storage area that is preferably accessible to the parcels during normal operation via a goods lock. In particular, the depot facilities contain means for protecting the parcels from unauthorized removal. Handover gates within the meaning of the present application may also be the storage compartments themselves, provided that these are equipped with a door which can only be opened after a release procedure has been carried out.

The invention further provides for a method for handing over a plurality of goods objects to a plurality of recipients, wherein the goods objects are stored and/or transported in parcels, such that in at least some of the parcels at least one goods object located in the parcel is made available to a recipient for removal, so that a handover of the goods object is carried out as the first handover process, that at least individual parcels are designed as reusable containers which are provided with individual identifiers and that the reusable containers are assigned parcel identification codes as a function of further information.

A particularly advantageous embodiment of this is characterized in that a first parcel identification code is assigned to the returnable container marked with the individual identifier until a first handover of a goods object contained therein to a first recipient, and in that a new parcel identification code is assigned to the returnable container provided with the individual identifier after it has been filled with at least one further goods object, in particular in such a way that the returnable container is processed by a logistics system as a further parcel without the returnable container having to be marked again for further processing operations within the logistics system.

A particularly preferred embodiment of the invention provides that the reusable containers are provided with individual identifiers and that package identification codes are assigned to the reusable containers depending on further information.

This means, for example, that a first package identification code is assigned to a returnable container with an individual identifier until a first handover of a goods object in it to a first recipient and that a new package identification code is assigned to the returnable container provided with the individual identifier after it has been filled with at least one further goods object.

This preferred embodiment makes it possible to use reusable containers as parcels without having to relabel the reusable containers for further processing operations within the logistics system.

Use of the identifier is advantageous in all embodiments of the invention, in particular in all embodiments of the method, the logistics system and the depot facility.

There are numerous ways of linking the reusable container with the unique identifier to a package identification code. It is particularly advantageous that the reusable container provided with the identifier is equipped with a first parcel identification code until a first transfer operation and that processing operations of the reusable container as a parcel are initially carried out taking into account the first parcel identification code.

Preferably, the identifier is transmitted to a control component of the logistics system as information on a parcel identification characteristic or directly as a parcel identification characteristic. Preferably, the control component receives both the information on the parcel identification characteristics and on the recipients of the respective parcels, in particular from an ordering system.

After handover of the at least one goods object contained in the returnable container, the link previously made between the returnable container with the identifier and the package identification code is removed, preferably by the control component of the logistics system.

By removing the assignment of the returnable container provided with the identifier and the package identification code, it is possible to link the returnable container with a second package identification code.

As soon as the returnable container is linked to a new parcel identification code, the further processing operations of the returnable container are carried out as a new parcel, taking into account the second parcel identification code, in particular without any consideration of the first parcel identification code.

According to the invention, the problem underlying the invention is further solved in that a logistics system for handover of a plurality of parcels, which is set up in such a way that it can hand over parcels of a plurality of shippers to a plurality of recipients and is further set up in such a way that it can carry out at least one processing operation of the parcels using a parcel identification code respectively assigned to the parcels, is designed in such a way in that, in the case of at least some of the parcels, in each case at least one goods object contained in the parcel is made available to its recipients for removal, so that handovers of the goods objects contained in the parcels are carried out as handover operations, but a handover of this part of the parcels is prevented during the handover operations, so that this part of the parcels is not handed over to the recipients of the goods objects.

An appropriate further development of the invention is characterized in that the parcel is handled up to the transfer process, taking into account a first recipient attribute, and in that further handling of the parcel takes place after the first transfer process and/or after the renewed loading of the parcel with a further goods object, taking into account a second recipient attribute.

In the present application, the phrase “first transfer operation” is used. This means in particular a handover of a first goods object to a recipient.

Following the first transfer process, the parcel, which is preferably designed as a reusable container, is used for transfer processes for other goods objects. These transfer processes are referred to as further transfer processes.

A preferred embodiment of the invention provides that the first transfer operation is carried out taking into account a first recipient attribute and that the further handling of the parcel after the first transfer operation and/or after loading of the parcel with a further goods object is carried out taking into account a second recipient attribute.

An advantageous embodiment of the invention provides that, in at least one of the handover operations, a decision is made as to whether a parcel belongs to the part of the parcels in which at least one goods object contained in the parcel is made available to a recipient for removal, but a handover of the parcel is prevented so that the parcel is not handed over to the recipient, or whether the parcel belongs to a further part of parcels which are handed over to the respective recipient in the handover operation.

Those parcels that are handed over to a recipient during one of the handover processes are preferably handed over together with the goods they contain. This can be done in the same way as conventional parcel handovers, for example, preferably in such a way that the parcels are handed over unopened.

An appropriate further development of the invention is characterized in that the decision process as to whether a parcel belongs to the part of the parcels in which at least one goods object contained in the parcel is made available to a recipient for removal, but a handover of the parcel is prevented so that the parcel is not handed over to the recipient, or whether the parcel belongs to a further part of parcels which are handed over to the respective recipient in the handover process, is carried out as a function of at least one property of the parcel.

The decision process preferably takes into account at least one of the following characteristics of the parcel:
Reusability of the parcel;
The parcel is open, in particular in the form of a container open at the top;
Possibility to open the parcel;
Reclosability of the parcel;
Labeling of the parcel.

An appropriate further development of the invention is characterized by the fact that the decision-making process takes place as a function of an instruction from the shipper and/or as a function of an instruction from the recipient of the parcel.

An advantageous embodiment of the invention provides that the decision-making process is dependent on a payment of a possible fee for a handover of the parcel to the recipient.

The depot facility according to the invention is preferably provided at a joint optimized handover point at least within a handover period. In the present application, the term “joint optimized handover point” is chosen for a geographically more precisely definable location, which is particularly suitable for the fact that several parcels can be handed over at it. Due to the possibility of handover of multiple parcels, this handover point is referred to as a joint handover point. The additional characterization as an optimized handover point means that the location is particularly suitable for the handover of parcels. In particular, this is a handover point that has been optimized using one of the selection procedures described in this application. In particular, joint optimized handover points are locations that are suitable for handover of as many parcels as possible, with as little effort as possible for the respective recipients of the parcels.

Preferably, at least a part of the parcels is transferred at the joint optimized handover points disclosed in this application. However, the advantageous parcel processing operations and parcel processing systems disclosed in this application are not limited to embodiments of parcel processing in which handovers of parcels occur at joint optimized handover points.

An advantageous embodiment of the invention provides that the selection of joint optimized handover points is carried out not only taking into account an effort parameter for the respective recipient and/or depositor, but also taking into account effort parameters for further recipients and/or depositors.

The advantageous embodiment of the invention provides for consideration of the respective effort parameter of as many recipients as possible, possibly even all recipients and/or depositors in the respective transfer period, for example on the respective day.

An advantageous embodiment of the invention is characterized in that the handover unit can perform a transport of a parcel between the depot facility and an individual handover point for an individual recipient of the parcel and/or an individual depositor of the parcel.

An appropriate further development of the invention provides that the handover unit can carry out the delivery of the parcel to the recipient and/or the acceptance of the parcel from the depositor at the individual handover point.

An advantageous embodiment of the invention is characterized in that the transport unit can autonomously carry out a transport as a handover unit from a location of the depot facility to the individual handover point for the individual recipient and/or for the individual depositor and can carry out the delivery of the parcel to the recipient and/or the acceptance of the parcel from the depositor at the individual handover point.

### BRIEF DESCRIPTION OF THE DRAWINGS

Further advantages and preferred embodiments of the invention are shown in the following illustration of preferred embodiments.

FIG. 1 shows a flow chart of an advantageous process according to the invention for explaining the sequence of processes taking place using a depot facility.

FIG. 2 shows an embodiment of a base plate of a holding device as it can be used in a transfer device.

FIG. 3 shows a further embodiment of a base plate of a holding device, as it can be used in a transfer device.

FIG. 4 shows a further embodiment of a base plate of a holding device, as it can be used in a transfer device.

FIG. 5 shows a schematic diagram of a logistics system according to the invention.

FIG. 6 shows a top view of a horizontal cross-sectional plane of a depot facility according to the invention with at least two shelves.

FIG. 7A shows an advantageous compartment configuration of a shelf according to the invention.

FIG. 7B shows an advantageous compartment configuration of a shelf according to the invention.

FIG. 7C shows an advantageous compartment configuration of a shelf according to the invention.

FIG. 7D shows an advantageous compartment configuration of a shelf according to the invention.

FIG. 8 shows a perspective view of a transport unit according to the invention.

FIG. 9 shows a top view of a transport unit according to the invention.

FIG. 10 shows an example of a bearing unit according to the invention.

FIG. 11 shows an example of a bearing unit according to the invention.

FIGS. 12A and 12B show a transport unit according to the invention, which can also be used as a handover unit.

FIGS. 12C and 12D show a schematic representation of a handover of a parcel in a region of a handover gate.

FIG. 13 shows a particularly preferred parcel from the prior art for handover.

FIG. 14 shows a schematic representation of a particularly preferred use of parcel identification characteristics and recipient attributes in a method for handover of a plurality of parcels from several shippers to several recipients by a logistics system with advantageous process steps.

FIG. 15 shows a schematic representation of a particularly preferred use of parcel identification characteristics and recipient attributes in a method for handover of a plurality of parcels from several shippers to several recipients by a logistics system with advantageous process steps.

### DETAILED DESCRIPTION

### Introduction

The present application relates to various inventions that are linked by the joint concept of delivering a large number of goods object to a large number of recipients with the smallest possible ecological footprint.

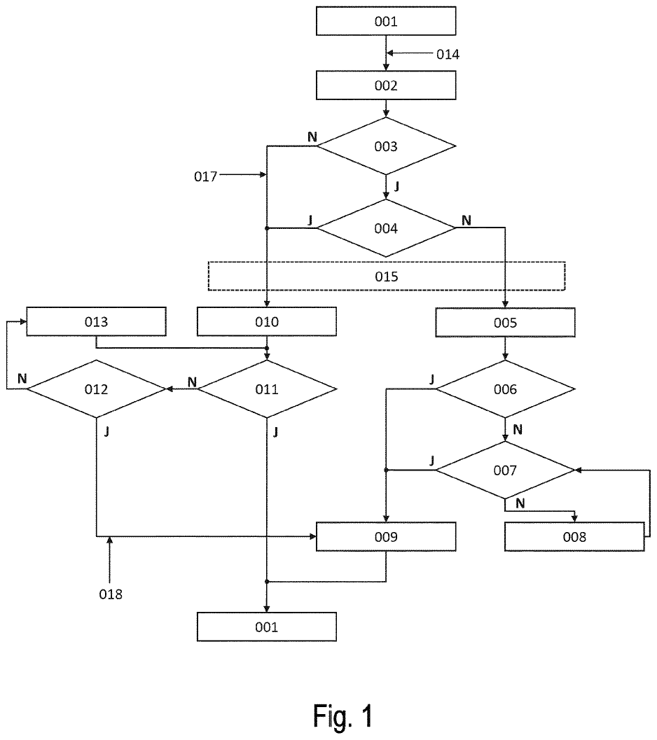

FIG. 1 shows a method according to the invention for explaining the sequence of processes taking place using a depot facility. The sequence of process steps and queries shown here is not intended to be restrictive of the method according to the invention, but is only one of many conceivable versions of the method. The depot facility is initially in the idle state or IDLE state 001. A recipient who wishes to receive his goods object and/or parcel makes a request 014 via an APP, for example, which is transmitted to the depot facility. This causes the depot facility to obtain information about the parcel using a parcel identification characteristic. The information includes whether the parcel is a returnable container. If the response to this query 003 is positive, the next query 004 checks whether a charge has been paid for the returnable container. The fee can be paid by the recipient, e.g., via an APP, or by the shipper. If the fee has not been paid, the handover device is instructed to hold the parcel, which is preferably designed as a returnable container, after transport 015 into the handover device during handover of the goods object 005 and, if necessary, to transport it to a storage unit of the depot facility.

Handover of the parcel to the recipient of the goods object can take place after one or more inspection processes.

The checking processes include, for example, checking whether and, if so, which instructions from the shipper and/or the recipient exist with regard to the handover of the parcel itself. In particular, it can be checked whether the recipient of the goods object has paid a fee for the transfer of not only the goods object, but also the parcel, or is willing to pay a fee for this.

The inspection processes may take place at different times, whereby an advantageous embodiment provides that an inspection process only takes place during the provision of the goods object for removal. A checking process that takes place during the provision of the goods object for removal is, for example, whether the recipient of the goods object pays a fee for the transfer of the parcel during the provision of the goods object or transmits information that he is ready to pay the fee.

One embodiment provides for the recipient to be able to pay the fee subsequently, even after the goods object has been seen, and for the parcel then no longer to be held. It is possible that the lid of the parcel, which is designed as a reusable container, has already been removed from the depot facility and the goods object in the parcel is made available to the recipient in the transfer device. It is also conceivable that the lid of the reusable container is designed as a type of disposable lid and that the recipient now removes this lid in the transfer device in order to gain access to his goods object. During the presentation of the goods, the recipient can be given the opportunity to determine the damage-free condition of his goods object and to offer him the option, e.g., via APP, to return the parcel on the spot (query 006). As long as the return option is not selected or in the event that this option is not implemented, the depot facility waits until the goods object has been removed 008. It can be advantageous for the recipient to be asked via the APP whether they agree to the parcel now being stored in the depot facility (query 007). If the recipient does not respond within a predefined period of time after removing the goods object or gives his consent via APP that the parcel can now be stored, the depot facility takes the parcel back and stores it 009. The depot facility then returns to its initial state, the IDLE state 001.

In the event that the parcel is not a reusable container, but a cardboard box or other outer packaging intended for single use, the parcel is not held on delivery 010. It can be advantageous to ask the recipient before the handover process, e.g., via APP, whether they would like to take their outer packaging with them or whether it should be disposed of in an environmentally friendly manner for a fee of e.g., 30 ct. The system either checks at regular intervals whether the parcel or goods have been removed (query 011) or automatically assumes after a defined time window (e.g., 15 seconds) that the parcel or goods have been removed. When the parcel is removed, the depot facility returns to its initial state 001 and waits for an instruction. In the event that a recipient leaves their outer packaging in the transfer device, although they have not selected the option in advance and the outer packaging is not intended for further use, the recipient is asked via the APP whether the outer packaging should be disposed of for a fee, for example for 30 cents (query 012), or whether they would like to take it with them. If the recipient denies this request, a period of time is waited 013 within which the parcel can be removed. If the recipient then fails to remove his parcel within the time period, he is charged the 30 cents and the parcel is stored 018 and the depot facility returns to the initial state 001.

It is particularly preferable that the proportion of parcels that are returnable containers is particularly high. By retaining or pledging the returnable containers, the cycle of returnable containers from shippers to recipients and back is closed and the proportion of returnable containers that are used for further transfer processes is as high as possible (e.g., >90%), so that a cost-efficient and ecologically sensible cycle is established.

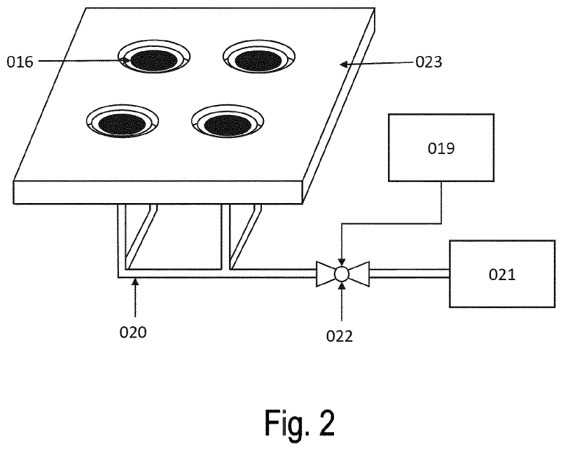

FIGS. 2 to 4 show holding devices as they can be used in the transfer device. FIG. 2 shows a base plate 023 of the transfer device, on which a parcel is placed using the transport unit of the depot facility. The base plate 023 has holes 016 into which, for example, bellows suction pads or the flat suction pads shown here are inserted. When a valve 022 leading to a vacuum pump 021 is opened by a control unit 019 of the depot facility, the suction pads use the vacuum to bring themselves into firm contact with the bottom of a parcel located above them. To release these suction pads, they can, for example, be pressurized so that no damage occurs to the reusable container when it is to be released from the suction pads. The connection of the lines 020 shown here is only one possible way of designing this holding device. It is also conceivable to create an alternative connection between the suction pads and the vacuum pump 021, for example a parallel connection.

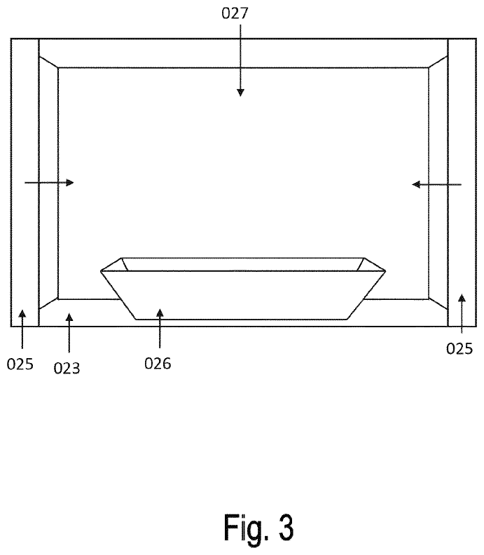

FIG. 3 shows an example of an alternative holding device in which a taper in the opening of the transfer device 027 facing the recipient prevents the parcel 026 from being removed by sliding two walls 025, which act as doors, closed according to the size of the parcel. The remaining opening is selected so that the recipient can remove the goods object, but not the parcel 026 itself. Due to its simplicity, this type of holding device is particularly useful for those parcels 026 that are designed as returnable containers and are not smaller than a certain minimum size.

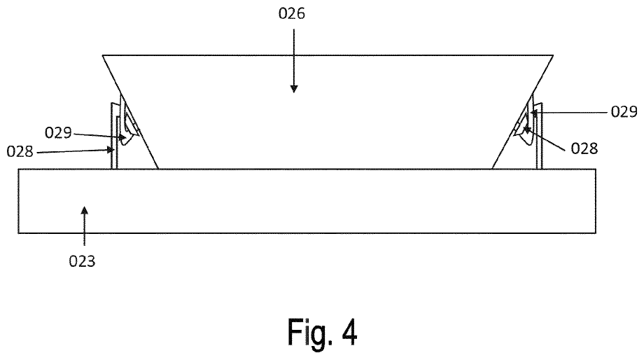

A further holding device shown in FIG. 4 uses lugs 029 possibly provided on the parcels 026, which can be engaged by means of hooks 028 built into the base plate 023, for example. The hooks 028 are embedded in the base plate 023 in the horizontal state and are inserted into the tabs 029 at the appropriate position when the holding device is activated, depending on the size of the parcel. This prevents the parcel 026 from being removed, but not the contents inside. In this holding device, the hooks 028 are not necessarily accommodated in the base plate 023, but can be attached in other areas of the transfer device 027 not shown here.

### Overview of the Logistics System and Logistics Processes Parcel Identification Characteristic

In the present application, the same parcel identification characteristics, in particular the same parcel identification characteristics and/or parcel identification characteristics that differ from other parcel identification characteristics, can be used to identify a parcel.

Unless parcels are expressly called data parcels or virtual parcels in the present application, parcels in the sense of the present invention are always physical objects, in particular with constant physical properties, in particular weight and dimensions. It is thus possible to ensure during the parcel's stay in a logistics system according to the invention that it is a specific parcel in each case. Different parcels usually differ in at least one physical property and can be distinguished from one another by measuring this physical property. These physical properties can therefore be used as parcel identification characteristics in an advantageous further development of the invention.

The parcel identification characteristic may also be, for example, a parcel identification code that uniquely identifies a parcel. Such a parcel identification code is, for example, applied to a parcel before it is transferred to a logistics system or a unit of the logistics system, for example one of the acceptance units shown in this application, for example the depot facilities shown, or the parcel identification code is applied to the parcel when it is delivered to the logistics system or during one of the processing operations within the logistics system.

The invention also includes preferred embodiments in which at least individual parcels, or as many parcels as possible, are designed as reusable containers. It is particularly advantageous if individual, several, as many as possible and preferably even all reusable containers are provided with an individual, preferably permanently identical identifier and that package identification codes are assigned to the reusable containers depending on further information.

Embodiments of the invention include embodiments in which the parcel identification code is a physical code which is applied, for example, to the parcel, an outer packaging of the parcel or to a storage unit for the parcel and/or a transport unit for the parcel and/or embodiments in which the parcel identification code is a digital code which is assigned to the parcel and/or a digital twin of the parcel.

Digital codes can be used as package identification codes, particularly in embodiments in which the parcels have unique identifiers, preferably in embodiments in which individual, several, many or possibly even all parcels are designed as reusable containers labeled with individual identifiers.

The use of digital codes as package identification codes is advantageous in all embodiments of the invention, and the use of digital codes in connection with digital twins is particularly advantageous.

It is advantageous if the respective digital twin of one of the parcels, preferably of several parcels, even more advantageously of as many parcels as possible, contains at least one parcel identification characteristic. In advantageous embodiments in which the parcel is associated with a parcel identification code, it is advantageous for the digital twin of the parcel to contain the parcel identification code.

It is appropriate to integrate at least one, advantageously several, even more advantageously as much information as possible into the digital twin of a parcel.

It is particularly advantageous to use parcel identification characteristics that are particularly easy to determine. This makes it possible to determine the identity of a parcel more quickly and/or with less effort.

A preferred embodiment of a parcel handling process according to the invention provides for a parcel identification code to be assigned and/or recorded and then stored as the primary parcel identification characteristic. Expediently, at least one further, more easily and/or more quickly identifiable characteristic of the parcel is used as a secondary parcel identification characteristic, in particular for checking the correctness of the primary parcel identification characteristic and/or for controlling a further processing operation. Examples of parcel identification characteristics that can be determined more quickly and/or with less effort are the weight and/or dimensions of a parcel.

Both the primary parcel identification characteristic and the secondary parcel identification characteristic can be parcel identification characteristics within the meaning of the present invention, wherein it is particularly advantageous to carry out processing operations, in particular processing operations of parcels, on the basis of one of these parcel identification characteristics.

A subsequent processing operation of the parcel can then be carried out based on a determination of the other parcel identification characteristic. For this purpose, it is advantageous, for example, to equip conveyor belts of transfer units with cameras for recording the dimensions of the parcels and/or with a scale and/or to equip transport units with a scale.

For example, it is determined that a parcel with a primary parcel identification characteristic in the form of a parcel identification code 123456789 has a weight of 5015.6 g. Subsequently, a measured weight of 5015.6 g +/−0.2 g can be used as a secondary parcel identification characteristic. The measurement of the weight thus represents, for example, a determination of an easier and/or faster identifiable secondary parcel identification characteristic, which checks the correctness that this is the parcel with the parcel identification code 123456789 and/or can be used instead of the parcel identification code for further processing. By checking the correctness and linking it to a digital image of the parcel, in particular its digital twin, the parcel is reliably identified.

The parcel with the parcel identification code 123456789 can already be assigned to a recipient and/or a handover point, in particular a joint optimized handover point for the handover of several parcels to several recipients and/or from several depositors, when it is delivered to the logistics system. However, it is equally advantageous to change the assignment to the recipient and/or the handover point for at least one of the parcels between posting and handover to a recipient of the parcel.

According to the invention, this general principle can be implemented in various processing operations, for example within one of the distribution centers according to the invention, in particular a sorting center and/or also for the storage of parcels in depot facilities according to the invention. For example, the parcel identification code of a parcel can first be determined and then one or more processing operations are carried out. For individual, several or all processing operations, consideration of a parcel identification characteristic is advantageous.

For example, it is possible to first determine a parcel identification code of a parcel and thereby reliably identify the parcel. Preferably, the parcel identification code is linked as a parcel identification characteristic with at least one other parcel identification characteristic, for example a weight and/or a dimension of the parcel. An image of the parcel can also be used as a parcel identification characteristic. This is particularly advantageous when goods objects are processed as parcels.

An advantageous further development of the invention provides that machine-readable data is assigned to the parcels, the data comprising at least one identifier with which the respective parcel can be identified, in particular uniquely identified. Expediently, at least one of the parcel identification characteristics shown in this application is used as the identifier for the respective parcel.

It is particularly advantageous to set a parcel identification code, for example digitally and/or by providing a parcel with a barcode or matrix code containing the parcel identification code or an RFID chip containing the parcel identification code, or to determine an already set parcel identification code, for example using a 6-sided scanner or an RFID reader.

Once the parcel identification code has been defined and/or determined, a controlled and/or measured transport route and/or sorting route for the parcel can be planned and/or tracked, for example by including a digital twin for the parcel, so that a subsequent processing operation for the parcel, in particular sorting of the parcel and/or transport of the parcel, can be carried out as precisely as is the case when the parcel identification code itself is determined, using a combination of the previously determined parcel identification code and a determination of another parcel identification characteristic that is preferably easier and/or faster to measure. As a result, the parcel is reliably identified even if a parcel identification characteristic is determined more quickly and/or with less effort.

A preferred further development of the invention envisages supplementing processing operations by providing process protocols, advantageously including individual process protocols for individual parcels, and/or using the process protocols provided for controlling processing operations. The use of individual process protocols for individual parcels has the advantage that real-time applications can be implemented and/or that a link between individual parcels and their respective digital twins is facilitated.

In a preferred embodiment, a preferred implementation of the assignment of parcels to shippers and/or recipients takes place by means of the links shown in this application and/or the likewise shown provision of process protocols, advantageously including individual process protocols for individual parcels, so that in particular a link between individual parcels and their respective digital twins is facilitated.

The information on the parcel identification characteristic is transmitted to a control component 5012. In the case shown, the control component 5012 receives both the information on the parcel identification characteristics and on the recipients of the respective parcels from the ordering system 5010.

### Prioritization of Shipments

The invention includes different ways of handling different parcels. In particular, the invention includes the fact that some of the parcels-as shown above-are already assigned to a recipient when the respective order is placed, as well as the fact that an assignment between parcel and recipient takes place at a later point in time.

This enables to carry out accelerated handovers of parcels for selected parcels and/or selected recipients.

Parcels can be flexibly assigned to recipients and/or user classes. This is relevant, for example, in the event of emergencies, including medical emergencies and/or technical emergencies, when parcels that are required for an urgent operation are to be given priority.

In addition to use in emergencies, this also includes procedures for handover of parcels that have an increased utility value for potential recipients of the parcels: For example, parcels for which a handover is only requested at a later date, in particular in a later handover period, can already be transported in such a way that they can also be handed over in an earlier handover period. In this case, for example, the recipient can be notified that they can pick up the parcel earlier if they wish; or another recipient authorized by the original recipient can submit a pick-up request for the parcel so that it is handed over to them instead of the originally intended recipient. Alternatively, the parcel may be delivered to a new recipient who has ordered it as particularly urgent and a “replacement delivery” is made to the original recipient at the same time.

### Introduction

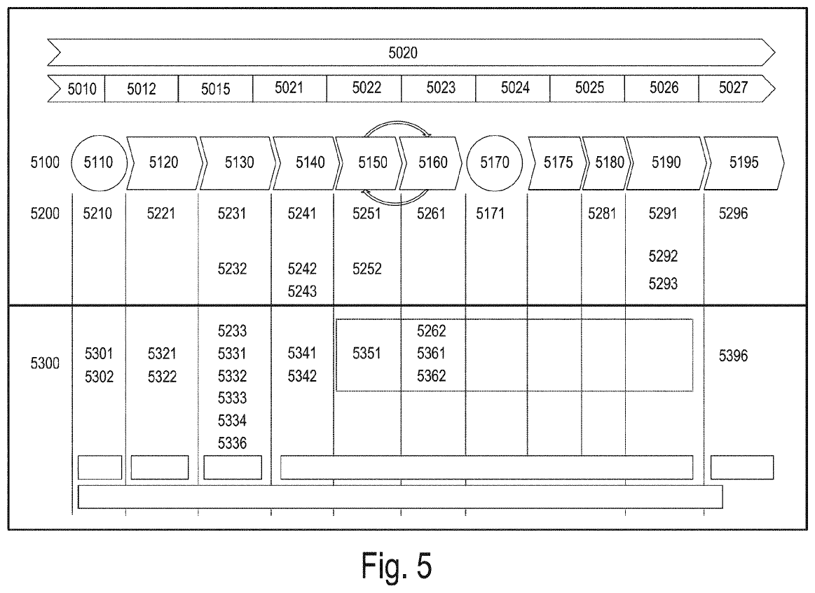

FIG. 5 shows a logistics system 5020 with an associated ordering system 5010.

An operator of a logistics system according to the invention can be both a provider of an ordering system, in particular a retailer, and a logistics system. Conversely, a retailer can also offer logistics services in addition to its ordering system.

The inventions described in this application can be integrated into eProcurement applications and eCommerce applications.

The central task of an operator of a logistics system according to the invention is the handover of the correct parcel to the correct, authorized recipient. To fulfill this task, it is necessary to ensure the unique identification of a parcel and the associated unique recipient.

Each parcel/goods object preferably has a reliable identifier as a parcel identification characteristic, for example an EAN code in the case of a goods object, an ISBN number in the case of a book, or a parcel identification number in the case of an overpacked parcel.

To correctly identify the recipient, unique characteristics such as e-mail address or mobile phone number are preferred in addition to name and home address.

Preferably, the logistics system 5020 shown in FIG. 5 includes, in the line labeled 5100, processing operations of parcels; in the lines labeled 5200, appropriate processing units for handling the parcels; and in the lines labeled 5300, preferred embodiments of the processing units shown in the lines 5200.

The processing operations and the processing units used can be combined with one another, whereby combinations that are as comprehensive as possible are particularly advantageous. In particular, the present invention is not limited to a specific combination of processing operations and processing units.

When combining individual processing operations and processing units, it is particularly appropriate to provide and use the processing units shown only where this is advantageous for the further processing of the parcels. For example, if the parcels are already transferred separately, measures for separating the parcels are not necessary. Similarly, parcel identification characteristics do not need to be recorded if the identity of the parcel is already known from one or more of the previous processing operations for the parcel.

For example, if a parcel identification code of a parcel has already been determined, it is not necessary to determine the parcel identification code a second time, but instead it is equally possible and in many embodiments more advantageous to carry out a subsequent identification of the parcel using another parcel identification characteristic that can be determined more quickly and/or with less effort.

A subsequent processing operation of the parcel can then be carried out based on the determination of the other parcel identification characteristic.

In addition to the usual components used in the environment of an operator of a logistics system according to the invention, it is advantageous to use individual, several, as many as possible or particularly preferably even all of the further components listed in lines 5300.

### Ordering System 5010

In particular, the ordering system 5010 is understood to be a system for instructing the posting and/or collection of parcels.

For example, the ordering system is a computer network with link interfaces for interacting with a large number of users.

In a preferred embodiment, the ordering system is a system with means for the electronic procurement of goods using a network, for example the Internet and other information and communication systems. It can be a purchasing system for companies or organizations as well as for private individuals.

Secure access to extranets or intranets, in particular VPNs (virtual private networks), which are specially secured and inaccessible to third parties, are preferred for ordering.

### Logistics System 5020

The logistics system advantageously concerns both “forward logistics” (from the mail order company or private shipper to the recipient) and “reverse logistics” (from the recipient or private shipper back to the mail order company or another recipient).

The logistics system 5020 according to the invention is preferably designed such that it can interact with one or more ordering systems 5010. These can be links in which the ordering system is embedded in the logistics system, but also links in which the logistics system 5020 receives handling orders for the parcels from the ordering system 5010.

A preferred variant is that the ordering system 5010 and the logistics system 5020 are linked in real time.

In particular in this case, a preferred embodiment of the ordering system 5010 provides that the ordering system comprises an input means for inputting one or more desired handover points for the handover of a parcel to a recipient of this parcel. By means of this information and the information required to identify the parcel and recipient, control of the parcel to the authorized recipient is ensured by the logistics system 5020.

It is therefore possible to operate the logistics system 5020 shown independently of an ordering system 5010. The information on the parcel identification characteristic is then transmitted from a separate ordering system-that of a third party-to the logistics system 5020. In the case shown, the logistics system 5020 receives both the parcel identification characteristic information and a unique identifier for the recipients of the respective parcels-for example, an e-mail address or mobile phone number.

In the absence of a separate ordering system, information to facilitate the selection of handover points for parcels to the recipient and/or from the recipient, in particular preferred handover points of the recipient, is recorded in an app component 5021 of a user and stored in a backend system 5021, 5022 of the logistics system 5020 of the operator of a logistics system according to the invention and, in an advantageous further development, supplemented by data containing as much of this information as possible in response to recorded information about a behavior of the recipient, in particular about distances travelled and choice of means of transport.

It is also possible to label parcels that are to be delivered to depot facilities. An addition such as “PAKETMOBIL handover” for delivery to depot facilities is not required on the label, but can be added.

### Link Interface 5015

As shown, the invention works with several ordering systems and/or ordering components, so that the ordering system 5010 shown is merely an example.

In a first advantageous embodiment of the invention, a logistics system 5020 known per se and an ordering system 5010 known per se are first linked together by the linking interface 5015.

The link is realized by at least one link interface 5015.

The linking interface 5015 is preferably configured to transmit instructions for handling the parcels and/or assigning the parcels to recipients.

In particularly advantageous further embodiments of the invention, the linking interface 5015 is further configured such that assignments of parcels to handover points and/or recipients can be changed.

By using the linking interface 5015, it is possible to assign a parcel to a shipper and/or a recipient even if shipper identification features and/or recipient identification features are omitted.

### Control Component 5012 of the Logistics System

The control component 5012 of the logistics system 5020 can be designed in such a way that it controls as many or even all of the processing operations of the parcels as possible. However, it is also possible for the control component 5012 to control only individual process steps described in this application.

The control component 5012 of the logistics system 5020 can perform one or more or even all of the methods described in this application, wherein the performance of the method, which is characterized in that a joint optimized handover point for the handover to the respective recipient within a certain handover period is determined for a plurality of parcels from a plurality of possible spatially separated handover points, taking into account at least one effort parameter, wherein a control of a handover to the recipients at the assigned joint handover point within the intended handover period by the control component 5012 is particularly advantageous.

Details of preferred embodiments of the control component and its interaction with the components of the logistics system according to the invention are shown below.

As already shown above, the control component 5012 of the logistics system 5020 can be designed in such a way that the control component 5012 controls as many or even all of the processing operations of the parcels as possible. However, it is also possible for the control component 5012 to control only individual process steps shown in this application. Preferably, information obtained from as many, and particularly preferably even all, of the components shown below is used:
5022: User APP for recording and managing user data as well as communication interface and control element of a depot facility
5023: User database of the user APP
5024: Network configuration module, in particular with a database for potential installation locations for mobile depot facilities;
5025: Network configuration tool for mobile depot facilities;
5026: Control module transport mobile depot facilities;
5027: Notification component;
Location information to determine the locations and/or storage positions of the parcels.

The following explanations refer both to the control component 5012 shown above with reference to FIG. 5 and to other control components that may be separate from the control component 5012 shown there. However, the control components shown below can also be operated independently of the control component 5012 and are not dependent on control by the control component 5012 shown in FIG. 5.

However, it is particularly advantageous to also use the embodiments illustrated in the further application text in the control component 5012 illustrated with reference to FIG. 5 and/or in further control components controlled by the control component 5012.

For targeted distribution of the parcels in the area of the transfer unit 5130, 5336 to the depot facilities, communication protocols of the parcel and line switching are usage and adapted to be able to handle the distribution of the parcels.

It is particularly advantageous to use telecommunication protocols for the control operations and/or for protocol operations, in particular packet-switched and circuit-switched telecommunication protocols and mechanisms for controlling parcel delivery, logistics and workflow management systems.

Among other things, the idea is implemented that the use and/or modification of protocols for handling data packets can also be used for processing operations of the physical parcels presented in this application, provided that they already offer a respectively required functionality. In order to achieve efficient handling of physical objects, in particular parcels, various additions can be implemented. Whereas parcels in the prior art have to be laboriously provided with labels that have to be created separately, the invention makes it possible to handle any physical objects-provided that dimensions and/or weights to be taken into account for the respective processing operations are complied with-in particular by means of one or more of the following processing operations:
Delivery;
Order picking;
Sorting;
Transportation;
Handover.

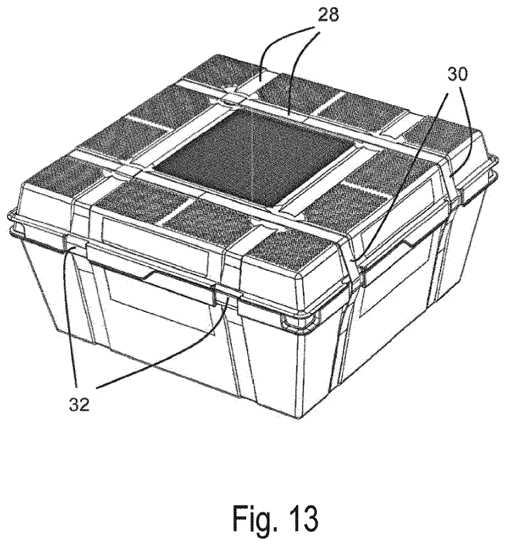

Parcels according to the prior art and goods objects according to the prior art-such as the exemplary parcel shown in FIG. 13-c an also be handled as parcels according to the invention, taking into account the processing operations shown.

An advantageous further development of the invention provides that further information is assigned to the parcels as machine-readable data, in particular by using digital twins. An example of the further information includes dimensions, in particular the spatial dimension of the parcel and/or the weight of the parcel, due date/time, penalties for late delivery, delivery costs, depositor and recipient information, material, fragility and parameters of the required transportation of the parcel, e.g., a refrigerated truck for goods that require refrigeration.

It is appropriate to add protocol functionality to the control components.

The protocol functionality can be used for various applications. Examples of these applications include managing workflows, retrieving statistical information, tracking parcels, controlling the forwarding of parcels, alarm handling and error handling.

Each parcel in a respective physical transport level can be accompanied by a digital twin, preferably as a logical parcel in a logical transport level, but this is not necessary.

In another advantageous embodiment of the invention, the logical transport level and the physical transport level are separate. The logical transport layer may be, for example, a local area network or the Internet. This allows a company to reuse the backbone network that is usage for voice and data transmission, e.g., an IP backbone.

Routing protocols are preferably used to support the determination of an optimal transport route between components of the logistics system according to the invention.

Examples of these routing protocols are metric-based routing and rerouting in the event of congestion, e.g., Open Shortest Path First (OSPF), Border Gateway Protocol (BGP).

The creation of virtual routes increases the flexibility of the transportation system.

It is also possible to associate at least part of the parcels with an IP protocol header to facilitate identification of the parcels. The IP protocol header can be one of the parcel identification characteristics according to the invention.

The different parcels that are processed, in particular sorted, transported and stored in the depot facilities, have different dimensions, masses and should meet different needs. The different needs are best reflected in special Quality Of Services (QOS) mechanisms. QOS specifications are, for example, fast or secure delivery. The QOS specifications are best categorized, e.g., according to special categories that represent goods objects that must be consumed soon or according to different security levels.

In an advantageous further development, the fulfillment of QOS specifications can be taken into account when determining the respective scoring value according to the invention.

Each of the routing protocols described can be used to minimize distances, costs, travel times, etc. and to use bandwidth as efficiently as possible.

Addressing is carried out by a domain name server (DNS), for example.

Special protocols for alarm processing or congestion control enable the system to react flexibly to unforeseen events.

It is also advantageous to implement multicast functions.

Scheduling mechanisms enable a further increase in efficiency.

To increase the reliability of communication and transport, the use of a Transmission Control Protocol (TCP) is advantageous.

Real-time processing is required for some parts of the processing of parcels, in particular for their sorting, storage and handover. To enable the system to react in real time, the usage of a Real-Time Protocol (RTP) is suitable. An example of a process based on RTP is the reordering of parcels, which is advantageous if the parcels have been routed differently.

It is also preferable to monitor the quality of service using a suitable protocol, such as the Real-Time Protocol (RTCP).

Packet sorting can be based on a packet-by-packet routing mechanism, e.g., in the case where there is no dependency between individual packets, but it can also be based on virtual connections, especially in the case where all packets take the same path through the network.

One reason for packet-by-packet routing can be congestion in parts of the network, different routes to be selected due to the fact that the parcels have different parameters (such as dimension or due date etc.).

In the logistics system according to the invention, parcels can be transported between different locations using any means of transportation. The location and/or the respective destination can be addressed using IP addresses. Intermediate storage can be performed using ICMP, flow control or a mechanism that forwards the digital twin and the physical parcel only after confirmation by any machine or human interface, e.g., one of the operators can use a web-based interface to control the forwarding of the parcel or to perform alarm processing.

Suitable control message protocols are implemented to enable monitoring, for example congestion control. One example of this protocol is the Internet Control Message Protocol (ICMP).

Further routing protocols are preferably used to select an optimal transport path from one physical distribution node to another physical distribution node or to the receiving point. Examples of these routing protocols are metric routing, cost-based routing.

The parcels according to the invention are physical parcels. It is advantageous to use an IP-based communication network for control, logging and/or notifications. In a preferred embodiment of the invention, this is achieved by the parcels preferably being accompanied by logical packets in a packet-switched communication network. Preferably, whenever the physical parcel is received in a distribution node, the distribution node informs the respective processing unit/processing component which processing operation is to be performed and waits for a confirmation that the actions have been performed.

In a preferred embodiment of the invention, the logical parcels shown are each treated as a digital twin of the corresponding parcel.

The two embodiments described above can be combined with each other or with any of the previously described embodiments.

It is advantageous to assign at least one IP address to each of the depot facilities according to the invention.

In addition to the usual components used in the environment of an operator of a logistics system according to the invention, it is advantageous to use individual, several, as many as possible or particularly preferably even all of the following further components:

### User App 5021, 5022

Reference numerals 5021, 5022 denote in particular a user APP for recording and managing user data as well as a communication interface and operating element of a depot facility.

It is particularly advantageous to provide users of the logistics system, in particular depositors or recipients of the parcels, in particular before carrying out the steps described, with an app, in particular a user app 5021, 5022 for recording and managing user data as well as a communication interface and control element of a depot facility, which advantageously allows the methods described in this application for selecting joint optimized handover points to be optimized by transmitting localization information of the recipients and/or the depositors to the control component 5012.

This makes it possible to take into account the localization information that the respective user shares with the user app 5021, 5022 as a component of the logistics system 5020, preferably the control component 5012, taking into account his respective data protection requirements, when selecting the handover points suitable for the respective user in the respective handover period. Such integration is performed for as many users as possible, so that joint handover points can be determined for a consolidated handover of parcels to multiple recipients.

Preferably, the user app 5021, 5022 can be designed in such a way that the user of the app as the recipient and/or depositor of parcels can use the user app 5021, 5022 to check which parcels, the dimensions of which are basically suitable for storage in storage positions of the depot facility 830, 5242, 5243, 5321, 5322, in particular within the scope of any maximum and/or minimum permissible parcel dimensions, are to be delivered or deposited to the depot facility 830, 5242, 5243, 5321, 5322. maximum and/or minimum permissible parcel dimensions to the depot facility 830, 5242, 5243, 5321, 5322.

Corresponding information in a user database 5023 should then be compared each day as early as possible with the consignment database, the digital twin and/or information of the logistics system, preferably information for controlling the processing operations, whereby the corresponding selection of the parcels to be transferred via the depot facilities 830, 5242, 5243, 5321, 5322 can be made by the logistics system 5020 depending on the extent to which the data systems are networked.

It is also possible to label parcels that are to be delivered to depot facilities. An addition such as “PAKETMOBIL handover” for delivery to depot facilities is not required on the label, but can be added.

Example: The user stores his e-mail address and delivery preferences in the user app 5021, 5022 and the user database 5023. The system now has a user with the unique e-mail address, e.g., bernd.einstein@gmail.com. As soon as the shipper sends the individual parcel information to the operator of a logistics system according to the invention, which also includes the e-mail address of the recipient (bernd. einstein@gmail. com), the system matches/marries both pieces of information (e.g., the e-mail address with the parcel identification code). All information relating to this parcel is now automatically sent to Bernd Einstein via the user APP 5021, 5022 or his transfer preferences are taken into account. If Bernd Einstein generally wishes handover to depot facilities, this delivery preference will be taken into account, even if the parcel does not contain the addition “Handover to parcel mobile”.

### User Database 5023 of the User App

The user database 5023 serves as the backend system of the user APP.

### Network Configuration Module 5024 and Network Configuration Tool 5025

In particular, reference numeral 5024 designates a network configuration module, preferably with a database for potential installation locations of mobile depot facilities.

A network configuration module 5024 is preferably designed such that it can determine joint optimized handover points for a handover of a plurality of parcels and, if necessary, additional individual handover points for individual handovers of parcels, in particular taking into account the presented effort parameters and/or scoring values.

As explained above, the ordering process can also be carried out in part in such a way that the person ordering a parcel selects one of several stored handover points and that the transport process of the parcel is then controlled in such a way that the transport is carried out to the selected handover point. However, it is particularly advantageous to control the logistics system and carry out the transportation of at least some of the parcels in such a way that the transportation is carried out to a handover point.

An advantageous embodiment of the invention provides for the selection of joint optimized handover points not only taking into account the effort parameter for the respective recipient, but also taking into account effort parameters for further recipients.

The invention provides for consideration of the respective effort parameter of as many recipients as possible, possibly even all recipients in the respective transfer period, for example on the respective day.

An advantageous further development of the invention is characterized in that the logistics system with the network configuration module 5024 has a means for detecting a plurality of possible storage locations for mobile depot facilities 830, 5242, 5243, 5321, 5322 and that it assigns the mobile depot facilities 830, 5242, 5243, 5321, 5322 to the handover points.

The network configuration module 5024 and/or the control component 5012 can perform one or more of the methods described in this application, wherein the performance of the method, which is characterized by the fact that for a plurality of parcels from a plurality of possible spatially separated handover points, taking into account at least one effort parameter-directly or indirectly by means of a scoring value taking into account an effort parameter-in each case a common optimized handover point for the respective recipient within a certain recipient, spatially separated handover points, taking into account at least one effort parameter-directly or indirectly by a scoring value taking into account the effort parameter-in each case a joint optimized handover point is determined for the handover to the respective recipient within a specific handover period, and which provides that the handover to the recipients, which takes place at the assigned joint optimized handover point within the intended handover period, by the network configuration module 5024 is particularly advantageous.

The scoring values are values with different dimensions, such as the quantification of an expense, which can be reduced to a key figure using the scoring tool.

However, it is also possible to take additional characteristics of the handover of the respective parcels to the respective recipients and/or the consignor into account when determining the scoring values, such as the dimensions or weight of the parcels, as these influence the effort required for collection and customer satisfaction.

The reference number 5025 designates a network configuration tool, in particular for the selection of joint optimized handover points and/or individual handover points, preferably as installation locations (sites) for mobile depot facilities.

Preferably, at least one component of the logistics system 5020, in particular the control component 5012 or the linking interface 5015 of the logistics system, preferably includes a network configuration tool 5025 that selects at least a portion of the handover points as locations for depot facilities 830, 5242, 5243, 5321, 5322.

The control component 5012 may be designed to control as many or even all of the processing operations of the parcels as possible.

The control component 5012 of the logistics system, or the logistics system 5020, controls a method according to the invention for handing over parcels to recipients in such a way that the parcels are provided to the recipients at handover points, in particular joint optimized handover points, within a (specific) handover period, the handover points being determined in such a way that effort parameters for the recipients are optimized as far as possible.

The effort parameter can be used directly, for example, to take into account the time that a recipient of a parcel or a depositor of a parcel has to spend from a location that he would also visit independently of a parcel handover—eh-da-location—as well as from a route that he would also travel independently of the parcel handover—eh-da-distance—to the handover point of the parcel, in particular the joint optimized handover point or the individual handover point.

Furthermore, scoring values can be used for which a reduction of the effort for the recipient improves the respective scoring value for the selection of the handover point according to the optimization of the effort parameters. It is of course possible to define the scoring values in such a way that the highest possible scoring value is the best scoring value, as well as to use scoring values for which the lowest values are the best values. For practical reasons, however, decimal systems are preferred, for example with values from 0 as the minimum value to 10 as the maximum value or from 0 as the minimum value to 100 as the maximum value.

It is particularly advantageous to design the network configuration tool 5025 in such a way that it controls a method for handing over a plurality of parcels in such a way that at least one scoring value is determined for each of a plurality of recipients of many possible, spatially separated handover points or, in the case of an optimization of individual effort parameters which is carried out with less computational effort, an optimization process according to the invention is carried out in such a way that a joint optimized handover point for a handover in a planned handover period is determined for a plurality of parcels. However, it is also possible for the control component 5012 to control only individual process steps described in this application. It is particularly advantageous to design the control component 5012 in such a way that it controls a method for handing over a plurality of parcels in such a way that at least one scoring value, or, in the case of an optimization of individual handover points which is carried out with less computational effort, a selection method (optimization method) according to the invention is carried out for a plurality of possible, spatially separated handover points, so that a joint optimized handover point for a handover in an intended handover period is determined for a plurality of parcels.

The scoring values are values that take into account the quantification of an expense for the recipients of the parcels.

In particular, the scoring values are values that reflect the time required for the individual recipients to receive the respective parcel.

Preferably, the scoring values are numerical values within a predefined number range.

In a first embodiment of the method, for example, the effort parameters for each of the recipients for receiving the parcel are taken into account. In this case, for example, with a number range from 1-10, a provision of the parcel in a depot facility 830, 5242, 5243, 5321, 5322 for which the recipient of the respective parcel has to spend 10 minutes to reach it is given a scoring value of 1 and a provision in the immediate vicinity of a location of the recipient or on a route already traveled by the recipient with an additional effort by the recipient of 1 minute or less is given a scoring value of 10.

Accordingly, the handover points are selected in such a way that the corresponding scoring value is as high as possible for as many recipients of the parcels as possible. However, it is also possible to provide a minimum scoring value to be achieved for individual recipients or individual parcels so that, for example, the additional time required by the recipient is no more than 5 minutes.

However, it is also possible to take additional characteristics of the handover of the respective parcels to the respective recipients into account when determining the scoring values.

This is done, for example, with a correspondingly larger number range for the scoring values by also assigning scoring values for the selection of the desired handover period, in particular for the shortest possible time until the earliest possible handover of the parcel and/or for the shortest possible time required to receive the parcels.

The assignment of the corresponding combination of these factors can be handled flexibly. In one embodiment of the invention, for example, it is provided that points are awarded both for the time between an order for a parcel and the associated handover period and for the time taken by the recipient to reach the handover point.

For example, it is possible to assign a corresponding contribution to the scoring value, for example a maximum of 50, for a handover on the same day as the order or even for delivery within a short period of time, which may be less than 1 hour. Furthermore, a contribution to the scoring value is then also awarded for the time taken to receive the parcel, for example a contribution to the scoring value of ten for a time taken of 10 minutes, a contribution to the scoring value of 20 for a time taken of no more than 5 minutes, a contribution to the scoring value of 30 for a time taken of no more than 3 minutes, a contribution to the scoring value of 40 for a time taken of no more than 2 minutes and a contribution to the scoring value of 50 for a time taken of no more than 1 minute.

For example, the delivery of a parcel within one week of the order with a delivery time of 10 minutes receives a scoring value of 10+10=20, the delivery of a parcel on the day of the order with an additional time expenditure for the recipient of no more than 1 minute receives a scoring value of 50+50=100.

However, it is also possible to define maximum times until the parcel is provided at the respective handover point as well as maximum efforts for receiving the parcels. This can be taken into account accordingly in a corresponding optimization process, so that, for example, recipients of a privileged user class are handed over in such a way that a scoring value of at least 70 is achieved, whereby this value, like the other values, in particular scoring values, can be flexibly adjusted.

Preferably, the control is carried out in such a way that several parcels are provided together at the joint optimized handover points for several recipients within the handover period.

In this context, it is appropriate that the provision of at least some of the parcels is carried out by depot facilities. The invention can be carried out with a plurality of depot facilities 830, 5242, 5243, 5321, 5322, including mobile or stationary depot facilities, which may differ from one another.

It is advantageous that the handover points are determined by a selection of spatially separated handover points.

Furthermore, it is appropriate that the selection from the spatially separated handover points is made by a selection process with several selection steps.

If a mobile depot facility 830, 5242, 5243, 5321, 5322 is provided for handover at the handover point, the handover point is preferably the installation site of the depot facility.

### Transport Control Module for Mobile Depot Facilities 5026

The control module 5026 controls the transport of the mobile depot facilities, including one or more of the transport operations shown below, which preferably include locations determined by optimization processes according to the invention:
between different nodes of the logistics system, for example between distribution centers,
between transfer units 5130, 5336 and the joint optimized handover points for the handover of parcels
between various joint optimized handover points
to locations for handover of individual parcels
the use of transfer means

Handover means are in particular the depot facilities and/or handover units cooperating with the depot facilities shown in this application.

### Notification Component 5027

Notification components 5027 can be used as in existing logistics systems, but it is advantageous to additionally take into account the flexibility of the handover points, in particular such that a preferably provided respective handover point is preferably notified to the recipients of the parcels when the control component 5012 has performed the selection of the handover points, in particular the joint optimized handover points.

Furthermore, it is possible to inform recipients of parcels, as soon as a parcel has been handed over to the logistics network for them, by means of suitable electronic communication channels, for example by e-mail and/or SMS or in an app, about an expected handover period and localization information, which may initially include several possible handover points, and to specify this localization information after the intended handover point has been determined and/or reached by notifying the handover point.

In a preferred embodiment of the notification component 5027, it is possible, in particular when integrating a notification function into the user APP 5021, to communicate localization information of the depot facility at the respective handover points of the parcel and preferably also additionally at the respective handover period.

When integrating a notification function into the app, a link to a navigation system and/or a map service on any terminal device of the recipient is particularly advantageous, so that the localization information and/or the handover period are forwarded to the navigation system and/or the map service of the recipient.

### Processing of Parcels 5100

In a preferred embodiment of the invention, the processing operations shown in line 5100 follow one another. It is particularly advantageous to perform several, in particular many, of the processing operations shown in line 5100, but it is not necessary to perform all of the processing operations shown in line 5100.

The handling of parcels according to the invention includes one, several or all of the following processing operations of a parcel:
Acceptance of the parcel, for example by posting, in particular by a depot facility 830, 5242, 5243, 5321, 5322;
Transportation of the parcel between the depot facility 830, 5242, 5243, 5321, 5322 and a depositor and/or a recipient of the parcel, in particular by a handover unit,
Transport of the parcel within the depot facility, in particular between a handover gate and storage positions of a storage unit of the depot facility;
Transportation of the parcel from a depot facility 830, 5242, 5243, 5321, 5322 to another depot facility 830, 5242, 5243, 5321, 5322;
Transportation of the parcel between the depot facility 830, 5242, 5243, 5321, 5322 and a transfer unit 5130, 5336;
Transportation of the parcel within the transfer unit 5130, 5336;
Sorting the parcel within the transfer unit 5130, 5336;
Transport of the parcel between the transfer unit 5130, 5336 and a distribution center 5301 for parcels;
Sorting the parcel within the parcel sorting center (parcel sorting centre)
Transport of the parcel between two distribution centers.

It is also advantageous to calculate parcel handling processes in advance by means of a simulation calculation before they are carried out. It is particularly appropriate here to provide a digital twin for each of the parcels and to compare the processing operations carried out on the parcels using the respective parcel identification characteristic with the pre-calculated processing process according to the simulation calculation. If there is a match between the parcel identification characteristic determined in each case and the respective associated digital twin, the respective parcel is identified accordingly. Such an advantageous identification of the parcel is also possible if a parcel identification characteristic is compared with another parcel identification characteristic determined in a previous processing operation.

### Parcel Processing in Distribution Centers 5110

In particular, column 5110 contains processing operations as well as processing units, especially with means for sorting parcels in the area of distribution centers.

Preferred embodiments of main runs and sorting processes 5110 are explained below. The control component 5012 of the logistics system 5020 passes information on parcel identification characteristics, which enable identification of the parcels, as well as information on the intended handover points to network nodes of the logistics system.

The control component 5012 of the logistics system, or the logistics system 5020, receives information on parcel identification characteristics, which enable the parcels to be identified, from preferably several sources of information, for example when the parcels are delivered by a detection means, by identification devices such as scanners and RFID readers in the area of distribution centers, in the area of transfer units 5130, 5336.

The control component 5012 of the logistics system, or the logistics system 5020, passes on information on parcel identification characteristics, which enable identification of the parcels, as well as information on the intended handover points, preferably to transfer units 5130, 5336 and/or to depot facilities. The forwarding of the information on the parcel identification characteristics both to the transfer units 5130, 5336 and to the depot facilities has the advantage that the storage of the parcels in storage positions of a storage unit of the depot facility 830, 5242, 5243, 5321, 5322 takes place quickly and reliably. A further advantage of this appropriate embodiment is that the storage in the storage positions of the storage unit of the depot facility 830, 5242, 5243, 5321, 5322 can be carried out without the use of sensor devices or other detection means in the depot facility 830, 5242, 5243, 5321, 5322.

Network nodes of the logistics system are, in particular, components of the logistics system in which decisions about processing operations to be carried out on the parcels are implemented. These are, for example, sorting processes 5110, which preferably take place in distribution centers 5301 for parcels. Examples of network nodes of the logistics system are preferably transfer units 5130, 5336 as well as transport units 5236 and depot facilities 830, 5242, 5243, 5321, 5322.

Here, the parcel identification characteristics are transmitted in such a way that the respective network nodes bring the parcels into the further transport process, taking into account the handover points selected in each case.

### Distribution Center 5301 and Delivery Depot 5302

In an advantageous embodiment of the invention, the delivery depots are designed as distribution centers. It is advantageous to use a two-stage or multi-stage logistics system in which parcels are preferably first transported to a distribution center, then from one distribution center to another distribution center and then from the other distribution center to delivery depots. The following processing operations take place, for example:
Selection of a distribution center 5301 that is particularly suitable for further distribution of parcels by loading depot facilities 830, 5242, 5243, 5321, 5322;
Initiation of a transport to the distribution center 5301 and/or to the delivery depot 5302;
An initiation of a transport to the depot facility;
Parcels are ejected in the area of a distribution center 5301 or delivery depot 5302

### Selection of Handover Points 5120

Preferably, the processing operations and processing units shown in column 5120 include means for selecting handover points, in particular joint optimized handover points of parcels, in particular with usage of depot facilities 830, 5242, 5243, 5321, 5322.

### Depot Facilities 5242, 5243, 5321, 5322

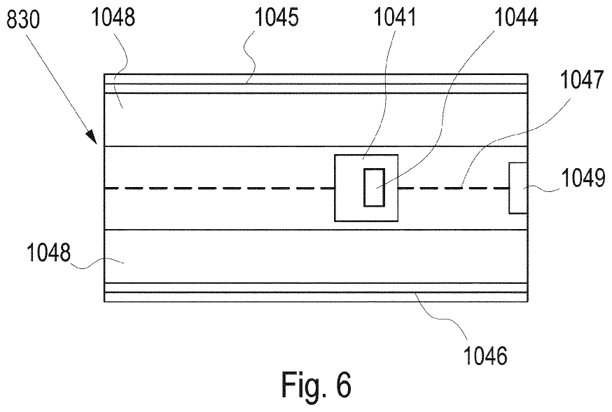

The depot facilities 5242, 5243, 5321, 5322 may be depot facilities 830, 5242, 5243, 5321, 5322 as shown in FIG. 6, but the logistics system is not limited to use cases with depot facilities 830, 5242, 5243, 5321, 5322, and even if depot facilities 830, 5242, 5243, 5321, 5322 are used, they may be designed differently from the examples shown in these figures.

In a particularly preferred embodiment, the depot facilities 5242 include a flexible adaptation of at least one storage unit 1410.

According to an equally preferred embodiment, the depot facility 5243 has a paternoster system.

The parcels stored in a depot facility 830, 5242, 5243, 5321, 5322 are preferably transported in the depot facility 830, 5242, 5243, 5321, 5322 to the handover points, in particular the joint optimized handover points.

The depot facility 830, 5242, 5243, 5321, 5322 preferably includes a handover gate for the parcels as part of the depot facility 830, 5242, 5243, 5321, 5322. The handover gate preferably also serves as a receiving device for parcels transferred to the depot facility 830, 5242, 5243, 5321, 5322 in the area of the handover points.

### Loading Preparation of Depot Facilities 5130

In a preferred embodiment of the invention, the processing operations and processing units shown in column 5130 include means and method steps 5233, 5331-5336 for a loading preparation of the depot facilities, in particular in the area of transfer units 5130, 5336.

The processing operation 5130 includes individual, several or even all of the processing operations for the parcels shown below:
Transfer of parcels from a distribution center;
Separation of parcels;
Transport of parcels from a distribution center to depot facilities;
Transportation of the parcels from one or more first depot facilities to one or more second depot facilities;
Preparation of the storage of parcels in depot facilities 5242, 5243, 5321, 5322 as shown in column 5140.

Individual, several or even all of these processing operations for the parcels are performed by the transfer units 5336 in a preferred embodiment of the invention.

The processing operations and processing units shown in column 5130 promote a transfer of parcels to depot facilities 830, 5242, 5243, 5321, 5322. In particular, these are processing operations in which several parcels are preferably transported directly one after the other to depot facilities 830, 5242, 5243, 5321, 5322 and are then preferably stored in depot facilities 830, 5242, 5243, 5321, 5322. The storage of the parcels in the depot facilities 830, 5242, 5243, 5321, 5322 is preferably carried out by placing the parcels in storage positions of storage units of the depot facilities 830, 5242, 5243, 5321, 5322.

In order to carry out the storage of the parcels in the depot facilities 830, 5242, 5243, 5321, 5322 as quickly as possible and/or in order to carry out the removal of parcels from the depot facilities 830, 5242, 5243, 5321, 5322 as quickly and reliably as possible, it is appropriate to use transfer units, examples of which are shown in FIGS. 6, 8 and 12. The transfer units shown in FIGS. 6, 8 and 12 are advantageous embodiments of transfer units 5336 according to the invention.

The transfer units 5336 may also include depot facilities 830, 5242, 5243, 5321, 5322 that serve as intermediate storage for parcels. In such a case, parcels are preferably first transferred to a first depot facility 830, 5242, 5243, 5321, 5322 and then removed again from this depot facility 830, 5242, 5243, 5321, 5322 and transferred to a new depot facility 830, 5242, 5243, 5321, 5322.

### Transfer Unit 5336

A further processing module, which in a preferred embodiment of the invention is controlled by control component 5012 of the logistics system, or the logistics system 5020, is a sorting module 5130, 5336 within the distribution center, which preferably also serves to divert the parcels to the depot facilities 830, 5242, 5243, 5321, 5322.

Preferably, a processing operation in the area of the transfer units 5130, 5336 comprises an autonomous separation 5231, an optimized alignment 5232 of the parcels and an optimized compartment allocation 5233-for storage positions of the depot facilities 830, 5242, 5243, 5321, 5322. The following processing operations are carried out by way of example:
Handover of the parcels at a transfer unit 5130, 5336 to the depot facilities 830, 5242, 5243, 5321, 5322; preferably using a transport unit 1241, 1641, 5341;
Transport of parcels from transfer unit 5130, 5336 to depot facility 830, 5242, 5243, 5321, 5322;

### Loading of Depot Facilities 5140

In an equally advantageous embodiment of the invention, the processing operations and processing units shown in column 5140 include means for loading the depot facilities, in particular for loading the depot facilities with individual parcels and advantageously also including parcel identification characteristics for the individual parcels.

Immediately after the storage of parcels in the depot facility in the distribution center 5301 has been completed, a data set is transmitted to the depot facility, preferably controlled by the control component 5012, while the depot facility is still present in the area of the distribution center, for example in the area of the transfer units 5130, 5336. Preferred contents of the data set are all relevant data required by the depot facility for the handover of the parcels now in the depot facility or for the acceptance of parcels that have already been notified. Preferably, these are for each parcel stored in the depot facility in the area of the distribution center or the transfer unit 5130, 5336:
Storage position within the depot facility;
A parcel identification characteristic;
Contact details of an intended recipient of the parcel;
Authentication features of the recipient of the parcel.

Preferably, these are for each parcel stored during a stay of the depot facility at a location, for example a joint optimized handover point into the depot facility:
size of the parcel
parcel identification characteristic
Contact details of the consignor
Authentication features of the consignor
Contact details of a recipient of the parcel;
Authentication features of the recipient of the parcel.

This means that the depot facility can operate autonomously at its location without permanent communication with the logistics system or the control component 5012; i.e., all parcels in the depot facility can be issued to the respective recipient on site at the location or already notified deliveries from shippers can be accepted and issued again.

### Storage and Removal 5241

Likewise, methods for supporting a storage of the parcels in storage positions of the depot facility 830, 5242, 5243, 5321, 5322 can be supported by the transport unit 1241, 1641 as well as other devices, for example a pusher 1430.

### Storage Units 5342

An advantageous embodiment of this method is characterized in that the parcels are assigned to predetermined storage positions on the basis of parcel identification characteristics, in that at least one transport unit 1241, 1641 moves along a transport path located in the depot facility 830, 5242, 5243, 5321, 5322 in such a way that it can remove parcels from a stream of parcels on the basis of the parcel identification characteristics, that, using the transport unit 1241, 1641, a transport of the parcels from the shipment stream into the depot facility 830, 5242, 5243, 5321, 5322 is enabled, wherein the transport of the transport unit 1041, 1241, 1641 within the depot facility 830, 5242, 5243, 5321, 5322 is controlled taking into account the storage positions assigned to the respective parcels on the basis of the parcel identification characteristics.

A particularly preferred processing operation for the parcel is:
Storage of the parcels by a transport unit 1241, 1641, 5341 in storage positions of the storage units: 5342 of the depot facility 830, 5242, 5243, 5321, 5322.

### Transportation and Installation of Depot Facilities at Locations 5150

According to an appropriate further development of the invention, the processing operations and processing units shown in column 5150 include means for transporting the depot facilities and for setting up the depot facilities at locations. According to a particularly advantageous embodiment, this includes parking the depot facilities at their respective locations in a manner that is as automated as possible.

According to an appropriate embodiment of the invention, the depot facility 830, 5242, 5243, 5321, 5322 is transported from one location to another location. In particular, the different locations are a distribution center 5301 and a location in a catchment area of recipients of parcels and/or depositors of parcels as a joint optimized handover point for several parcels and/or also the sequential approach of several joint optimized handover points.

As soon as the depot facility has reached its output location, in particular at a joint optimized handover point, the depot facility sends this information to the control component 5012. The control component 5012 in turn informs, for example using notifications to user APPs 5021, 5022 and/or user components of recipients, as many, preferably all, recipients for whom a parcel is stored in the depot facility as possible with information about
the specific location of the depot facility,
with the time period of availability of the depot facility on site (e.g., also with countdown functionality/clock), i.e., with information on the handover period for a parcel handover at the location of the depot facility;
a link for a route description from the recipient's current location to the location of the depot facility (with an indication of the time required);
Possibly additional information regarding weather, traffic situation and vouchers from a retailer near the location of the depot facility.

A transport of the depot facility 830, 5242, 5243, 5321, 5322 to further locations can be controlled by the control device 5150 or a request unit 5180, 5281.

Previously, a preferred further development of the processing operations and processing units shown in column 5190 has already been disclosed, in which means for transporting the depot facilities to the transfer units 5130, 5336 and/or from a first installation location to a further installation location are used as a further location for installing the depot facility. However, it is equally possible that at least some of the depot facilities are located at a location for a longer period of time than the intended transfer periods or are even stationary, where stationary also includes partial stationarity, for example by a reversible connection of the depot facility 830, 5242, 5243, 5321, 5322 with another depot facility 830, 5242, 5243, 5321, 5322 and/or another fixed reference point.

### Control Device for Autonomous or Semi-Autonomous Transportation 5251

Preferably, the logistics system 5020 also includes control devices 5150, 5151 for controlling the transport of the parcels to the respective handover points. These ensure that a depot facility 830, 5242, 5243, 5321, 5322 containing the respective parcels is transported to the respective handover point.

The control devices 5150, 5151 can be parts of the control component 5012 and/or interact with the control component 5012.

It is advantageous that transport operations of the depot facilities 830, 5242, 5243, 5321, 5322 are also controlled by the control component 5012 and/or that the control component 5012 transmits control commands to other control units, in particular vehicle control units 5150, 5151, for controlling the transport of the depot facilities 830, 5242, 5243, 5321, 5322. The corresponding control takes place taking into account a degree of autonomy of the transportation means for transporting the depot facilities. It is advantageous to use vehicles, mobile robots and, where appropriate, driverless transport systems-hereinafter collectively referred to as vehicles which have the highest possible level of autonomy that can be reliably achieved. The respective environment of the vehicle is controlled in particular at autonomy levels 3, 4 and 5. However, it is also possible to use remote-controlled vehicles. The use of a remote control has the advantage that with a relatively low level of autonomy, a driver can control the vehicle on the basis of the control commands from the control device 5150 during the entire route or during driving sections that cannot be driven autonomously.

From autonomy level 3, permanent control by a driver is not required, but rather only an interface that enables a human driver to react appropriately in a short time at the request of a vehicle system. At an autonomy level of 4 or 5, there is generally no need for a driver to intervene remotely. In particular, at an autonomy level of 4, the driving mode of the depot facilities 830, 5242, 5243, 5321, 5322 is controlled in such a way that all aspects of dynamic driving tasks can be performed by the automated driving system itself.

This is advantageously supported by deployment scenarios in which depot facilities 830, 5242, 5243, 5321, 5322 are transported outside rush hours, preferably before the morning rush hour or after the evening rush hour, where usually a transportation of the depot facilities 830, 5242, 5243, 5321, 5322 are usually transported from the transfer units 5130, 5336 to the handover points before the morning rush hour and the depot facilities 830, 5242, 5243, 5321, 5322 are transported back to the transfer units 5130, 5336 after the evening rush hour. This ensures that the respective depot facility 830, 5242, 5243, 5321, 5322 can be reached with as little effort as possible during normal times of day when many recipients are in the vicinity of the depot facilities or travel distances that are close to the handover points.

According to an appropriate further development of the invention, the processing operations and processing units shown in column 5190 include means for transporting the depot facilities to the transfer units 5130, 5336 and/or from a first installation location to a further installation location as a further location for installing the depot facility.

According to a particularly advantageous embodiment, the transport, including parking of the depot facilities 830, 5242, 5243, 5321, 5322, which is as automated as possible, takes place in the area of the transfer units 5130, 5336 or at the joint optimized handover points.

### User Component 5351

It is advantageous to design the logistics system, or one or more of the components of the logistics system, in such a way that they can interact with user components 5351 via a user interface, in particular to respond to requests for the handover of parcels. The user component 5351 is, for example, a smartphone, a smartwatch or smart glasses. In particular, the user interface is designed such that it can transmit information that initiates a handover of parcels and/or improves the handover of the parcels. Examples of the information that can be transmitted include parcel identification characteristics, user identification characteristics, authentication data and notification information.

The interaction of the logistics system component with the user components 5351 can be realized in various ways.

In principle, it is possible to design several of the illustrated components of the logistics system in such a way that they can interact with a user component 5351, but it is particularly appropriate if at least one of the components is a depot facility 830, 5242, 5243, 5321, 5322.

Another component of the logistics system in which user interface integration occurs is a preferably mobile depot facility 830, 5242, 5243, 5321, 5322 adapted to dispense and/or accept parcels.

### Handover of Parcels to Recipient 5160

In a particularly preferred embodiment in the invention, the processing operations and processing units shown in column 5160 include means for handover of parcels to recipients.

As described above, the notification component 5027 transmits the following information to the recipient of a parcel, for example, requesting him to collect his parcel:
“Dear Mr. Müller, Your parcel is available for collection from the Parcel Mobile until 9 p.m. today, at Philipsstraße 8, 52068 Aachen ready for you” You can find the fastest way to your parcel here. Your ParcelMobile Team”

The handover of the parcels located in the depot facilities 830, 5242, 5243, 5321, 5322 to the recipients, also referred to herein as handover, can be controlled directly by the user APP 5021, 5022. Furthermore, authentication of the recipients is preferably performed by an authentication module.

This is possible, for example, if a recipient who is a user of an app has configured it in such a way that his approach to a depot facility 830, 5242, 5243, 5321, 5322 already initiates a handover process.

It is appropriate to provide an authentication module 5262 for an exchange of authentication information with the user component 5351 of the recipient and/or an app, in particular the user app 5021, 5022, so that authentication of the user is facilitated.

Alternatively, or additionally, the user can be identified using biometric information.

The authentication module 5262 preferably interacts with the control component 5012 and/or with the local control unit 5170, 5171.

The approach of the recipient to the depot facility 830, 5242, 5243, 5321, 5322 can be determined by means of various location determination systems including satellite-based positioning systems, localization via a mobile network, a WLAN and/or via NFC, whereby such localization methods sometimes enable location accuracies in the cm range.

As soon as the recipient now approaches the corresponding depot facility within a near-field radius of, for example, 5 m to 50 m, preferably 10 m to 20 m, the depot facility registers this independently, for example via near-field communication, and/or the control component 5012 of the logistics system registers this based on localization information received from the recipient, which is determined, for example, using GPS data or positioning within a mobile communication network.

After the proximity of the recipient to the depot facility is detected, its user app 5021, 5022 and/or user component receives a notification. After receiving the notification, the user app 5021, 5022 and/or the user component is switched to a different operating state, in particular activated. This can also be done standalone by the depot facility or via the logistics system, preferably the control component 5012 of the logistics system.

Preferably, the recipient now receives a prompt from the user app 5021, 5022 and/or the user component asking whether they would like to remove the parcel from the depot facility immediately. If the recipient confirms the request to remove the parcel, they are asked to authenticate themselves via the app (e.g., via touch ID or password entry, etc.). Authentication can also be carried out standalone by the depot facility and/or by the control component 5012 of the logistics system. If the authentication is positive, the recipient is also located directly at the depot facility (e.g., no more than 2 m away) and handover of the parcel is possible, the depot facility enters the handover of the parcel.

The aforementioned handover of the parcel is possible in particular if one or more of the aforementioned characteristics are fulfilled:
there is no other recipient of the parcel before the recipient of the parcel;
no parallel transfer processes of parcels take place at the depot facility;
a handover unit is available for handover of the parcel at an individual handover point.

### (Local) Control Unit for Handover of Parcels 5170

Particularly advantageous embodiments of processing operations and processing units in the area of a possibly local control unit for enabling handover of the parcels are shown in column 5170.

A control unit 5170, 5171 controls several, preferably many, even more advantageous all processing operations in the area of the depot facilities, in particular when the depot facilities are installed in the area of the installation locations.

Examples of the processing operations controlled by the control unit 5170, 5171 are:
Use of depot facilities for the storage of parcels;
Use of depot facilities for sorting parcels;
Use of depot facilities for picking parcels;
Use of depot facilities as sales facilities;
Control of transfer processes in the depot facility area.

As an alternative to control by the user APP 5021, 5022, it is also possible to control the handover of the parcels by a local control unit 5170, 5171 in the depot facility, wherein the local depot facility 830, 5242, 5243, 5321, 5322 receives assignment information between the parcel and recipient from the database 5023, if necessary, and performs the handover taking into account the assignment information or an authorization transmitted by the database 5023.

It is particularly advantageous to use the control unit 5170, 5171 as a local control unit 5170, 5171 in the area of the depot facility 830, 5242, 5243, 5321, 5322, in particular to design the local control unit 5170, 5171 in such a way that it controls the depot facility 830, 5242, 5243, 5321, 5322 in such a way that handover of the parcels is also made possible independently of the control component 5012. This design of the depot facilities 830, 5242, 5243, 5321, 5322, each with a local control unit 5170, 5171, has the advantage that operation of the depot facilities 830, 5242, 5243, 5321, 5322, preferably including a delivery of parcels and a handover of parcels, is possible even if, for example, there is no data connection between the depot facility 830, 5242, 5243, 5321, 5322 and the control component 5012.

Notifications to the recipient about the possibility of collection by the recipient can be made in particular when one of the following procedural steps is reached:
Delivery of a parcel to a depot facility; especially in the case of stationary depot facilities;
Start of a transport of a mobile depot facility containing the parcel;
Reaching a location designated for the handover of a mobile depot facility containing the parcel;
Information that a parcel stored in the depot facility 830, 5242, 5243, 5321, 5322 can be assigned to a recipient.

### Handover of Parcels at Individual Handover Points 5175

Advantageous embodiments of processing operations for performing and improving a handover of parcels at individual handover points are shown in column 5175.

There are several advantageous variants for handover of parcels to an individual recipient at an individual handover point.

An advantageous variant is the handover to an individual recipient at an individual handover point by the depot facility itself. Thus, after leaving the joint optimized handover point for the handover of several parcels to several recipients and/or from several depositors, the depot facility can travel to different individual addresses one after the other and carry out a handover of one or more parcels there.

For the handover of one or more parcels, it is possible to determine an individual handover period and/or individual handover point by means of one of the selection methods disclosed in this application, in particular the methods described for optimizing handover points.

It is advantageous to first determine the individual handover period and/or individual handover point with a confidence interval that can be selected if necessary. The confidence interval preferably relates to the individual handover period and/or the individual handover point, which is agreed with the recipient and/or communicated to the recipient.

An appropriate embodiment of the invention provides that the control component controls the processing operations in such a way that the handover of the parcel in the individual handover period and/or at the individual handover point is carried out with the minimum probability as soon as the individual handover period and/or individual handover point can be agreed with the recipient with a minimum probability of, for example, at least 95%, preferably significantly closer to 100%. An equally advantageous embodiment of the invention provides that the handover of the parcel can be carried out in the individual handover period and/or at the individual handover point with a minimum probability of, for example, at least 95%, preferably significantly closer to 100%, to the recipient. The recipient is then informed of the handover possibility. Preferably, the control component transmits a notification of the handover possibility by means of a user component 5351 of the recipient and/or an APP, in particular a user APP 5021, 5022, and thus informs the recipient.

It is advantageous, as an alternative or in addition to the notification shown in the previous paragraph, to transmit a notification to the individual recipient immediately after the arrival of the depot facility at the individual handover point, preferably by means of a user component 5351 and/or an app, in particular a user app 5021, 5022, about the immediate handover possibility and thus to inform him. The handover process is preferably analogous to the process at a joint optimized handover point.

Another advantageous variant of handover to an individual recipient at an individual handover point is handover by an autonomous handover unit. It is also possible to use the transport unit as a handover unit that can transport parcels between the depot facility and individual handover points for handover of parcels to individual recipients.

The individual recipient is informed of the immediate handover option via APP as soon as the handover unit arrives at the individual handover point. As soon as the recipient has authenticated themselves directly in front of the handover unit, the handover unit releases the parcel for the recipient.

### Request Unit for Handover at Individual Handover Points 5180

According to an appropriate further development of the invention, the processing operations and processing units shown in column 5180 include means for determining individual handover points for the individual recipients of the parcel and/or the handover of the parcel to the recipient and/or the acceptance of the parcel from the depositor. This is done in particular by a request unit 5180, 5281 for a handover of the parcel at an individual handover point, in particular in the area of the depot facility by the depot facility itself and/or a handover unit. This applies in particular to handovers of parcels at joint optimized handover points and/or at individual handover points for individual recipients and/or depositors of parcels. The handover of parcels at individual handover points can include both the integration of a “front door handover” and the handover of parcels for a definable group of recipients and/or depositors, in particular at individual handover points.

In particular, the request unit 5180, 5281 is set up so that it can interact-preferably via a user interface with user components 5351 and/or an APP, in particular a user APP 5021, 5022, in particular react to requests for the handover of parcels. The user component 5351 is, for example, a smartphone, a smartwatch or smart glasses. In particular, the user interface is designed such that it can transmit information that initiates a handover of parcels and/or improves the handover of the parcels. Examples of the information that can be transmitted include parcel identification characteristics, user identification characteristics, authentication data and notification information.

In particular, it is advantageous to realize the request unit 5180, 5281 as a component of the logistics system 5020.

Examples of the use of individual handover points are locations for depot facilities that are set up so that parcels are only handed over to a definable group of recipients and/or consignees.

Preferably, a request unit 5180, 5281 initiates a packet handover at an individual handover point.

### Delivery of Parcels 5190

Advantageous embodiments of processing operations and processing units in the area of storage of parcels, goods objects and returned goods, preferably by means of a local control unit to enable the parcels to be delivered, are shown in column 5190.

There are several advantageous embodiments of processing operations and processing units in the area of a storage of parcels, goods objects and returned goods, preferably by means of a local control unit for enabling a delivery of the parcels, are shown in column 5190.

It is also appropriate to design the logistics system in such a way that it is set up to carry out a method for receiving a plurality of parcels from a plurality of depositors, which is characterized in that a joint optimized handover point for receiving from the depositors within a certain handover period is determined for a plurality of parcels from a plurality of possible spatially separated handover points, taking into account at least one effort parameter, and in that the receipt from the depositors takes place at the assigned joint handover point within the intended handover period.

Preferably, a receipt of a parcel represents a delivery of the parcel to a depot facility 830, 5242, 5243, 5321, 5322 and/or a handover to a handover unit represents a delivery to the logistics system.

It is particularly advantageous to design the logistics system in such a way that it is set up to carry out a method for handover of a plurality of parcels to a plurality of recipients and for acceptance of a plurality of parcels from a plurality of depositors, characterized in that in that a joint optimized handover point for the handover to the respective recipients and for the acceptance from the depositors within a certain handover period is determined for a plurality of parcels from a plurality of possible spatially separated handover points, taking into account at least one effort parameter, and in that the handover to the recipients and the acceptance from the depositors takes place at the assigned joint handover point within the intended handover period.

It is advantageous to perform one or more of the following processing operations in the area of the depot facility 830, 5242, 5243, 5321, 5322:
5291 Individual storage of goods objects from shippers;
5292, “true” first mile, in particular as delivery of the parcel into the logistics system to perform one or more of the processing operations disclosed in this application;
5293, return transport of a parcel stored in the depot facility but not handed over at the joint optimized handover point within the handover period.

It is advantageous to determine the extent to which storage positions of the depot facilities 830, 5242, 5243, 5321, 5322 are not occupied by the packages assigned for handover at the respective handover points of the depot facility 830, 5242, 5243, 5321, 5322 assigned by the control component 5012 and to use these unoccupied storage positions for storage and handover of goods objects, which are also referred to as parcels in the context of this application, including for storage of returns or “genuine first mile shipments” by/in the depot facility 830, 5242, 5243, 5321, 5322.

It is also possible to set up the depot facilities 830, 5242, 5243, 5321, 5322 such that storage positions not provided for a local handover to the depot facilities 830, 5242, 5243, 5321, 5322 in the area of the handover points are communicated to the local control unit 5170, 5171 and/or the control component 5012 for storage of parcels in the depot facility 830, 5242, 5243, 5321, 5322.

### Return of the Depot Facility and Removal 5195 of the Parcels

It is particularly advantageous to minimize the number of parcels not transferred to recipients and instead to perform processing operations, in particular processing operations in the area of the depot facility 830, 5242, 5243, 5321, 5322, in such a way that as many as possible of the parcels in the depot facility, including in the area of the depot facility 830, 5242, 5243, 5321, 5322, are transferred to recipients, including alternative recipients for the otherwise not transferred parcels.

The inclusion of recipients to whom respective parcels are only assigned after one or more processing operations is particularly advantageous. In particular, it is appropriate to determine an alternative recipient for at least some of the parcels, especially for parcels to which no recipient has been assigned, so that handover of the parcel to the alternative recipient takes place, in particular as a goods object.

After the end of the handover period, the depot facility 830, 5242, 5243, 5321, 5322 is transported on to further handover points or to a transfer unit 5130, 5336 in a process step 5195.

In process step 5195, those parcels that are not intended for handover by the depot facility 830, 5242, 5243, 5321, 5322 in a subsequent handover period, in particular parcels not collected within the intended handover period or parcels intended for further transport to the handover gates, are removed from the depot facility 830, 5242, 5243, 5321, 5322.

The removal of the parcels not intended for handover by the depot facility 830, 5242, 5243, 5321, 5322 in a subsequent handover period is preferably performed in an automated handling process 5296, 5396.

### Handover of Goods

Embodiments of the invention include instances where parcels, including items of merchandise referred to herein as parcels, are held in depot facilities 830, 5242, 5243, 5321, 5322 and are only transferred to a recipient of the parcel immediately in response to a purchase of a respective parcel.

The invention also includes different ways of handling different parcels. In particular, the invention includes the fact that some of the parcels, as shown above, are already assigned to a recipient when the respective order is placed and that a parcel is assigned to a recipient at a later point in time.

This makes it possible to carry out accelerated ordering procedures for parcels and/or recipients, in the sense that parcels are already on the transport route before they are actually ordered.

However, the invention also includes advantageous embodiments in which a link between parcels and recipients also takes place independently of an ordering process or in which a parcel whose transport has already been initiated or which is on a transport route to a recipient or a handover point or which is located in a depot facility 830, 5242, 5243, 5321, 5322 is linked to handover information for controlling a handover to another recipient. This recipient may be a recipient that has been entered into the ordering system via an interface, for example, as well as a subsequent purchaser, including a person who first performs at least one component of a purchase transaction, including a spontaneous purchase directly at the depot facility, in a catchment area of a depot facility 830, 5242, 5243, 5321, 5322.

It is possible to keep any items ready for handover to recipients in the depot facilities 830, 5242, 5243, 5321, 5322 as parcels, both for recipients to whom the respective items were already assigned during or before their storage in the respective depot facilities 830, 5242, 5243, 5321, 5322 and for items to be kept ready which are only assigned to a recipient after their storage in the depot facility, possibly also only immediately before their handover.

The present invention is suitable both for use with individualized parcels, in which it is relevant that a parcel with a previously defined content is transmitted to a previously defined recipient, and for use for the handover of goods, in particular bulk goods including such goods for which there is no defined recipient before storage or during storage, possibly even during handover, but in which a person not identified in advance can also be the recipient, for example in the embodiment of the depot facility 830, 5242, 5243, 5321, 5322 as a sales facility.

In order to enable handover of goods, it is advantageous to transport the goods as goods objects-preferably using a depot facility 830, 5242, 5243, 5321, 5322 according to the invention. During the handover of goods objects, several parcels can be provided within one storage position, depending on the respective dimensions of the goods objects. In such an application, it is appropriate to use product codes or codes already used and applied by the shipper, which are already applied to a large number of goods objects, as parcel identification characteristics.

Furthermore, it is possible to assign parcels containing an interchangeable good, in particular a good that is produced several times with the same properties, to a recipient, preferably a preferred recipient, for example a buyer, during a transportation process to a depot facility 830, 5242, 5243, 5321, 5322 or only within the depot facility 830, 5242, 5243, 5321, 5322.

The depot facilities 830, 5242, 5243, 5321, 5322 can also be components of the ordering system and contain input means for identifying one or more goods objects. This goods object or these goods objects are combined into parcels, each parcel usually containing one or more goods objects. The provision of one or more goods objects as a parcel also includes the case where the goods objects themselves are each shipper as parcels. Preferred embodiments of the invention provide for largely contactless or even completely contactless handling of the parcels during sorting at a distribution center in a destination area of a recipient and on the last mile to the recipient, so that in many cases it is also possible to dispense with repackaging of the goods objects.

### Mobile Depot Facility

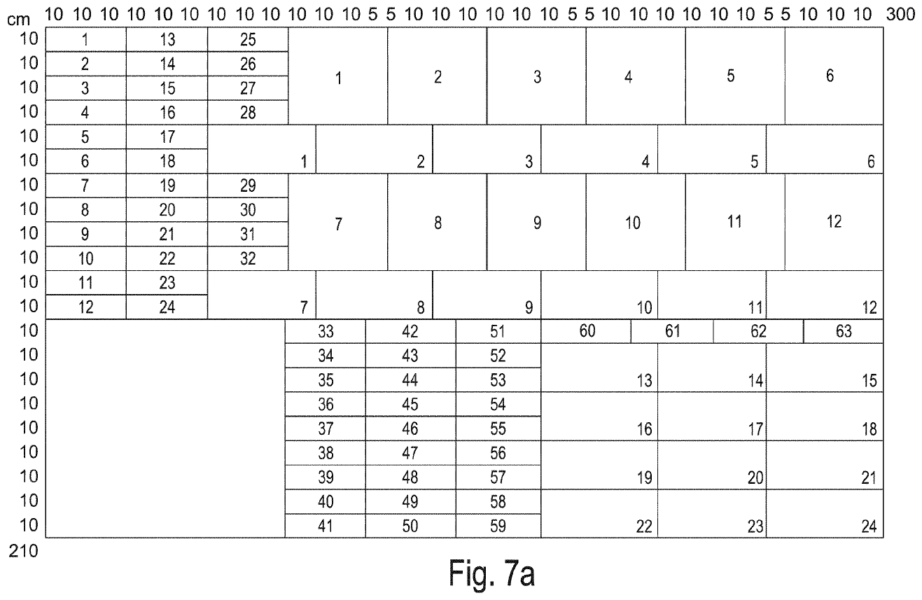

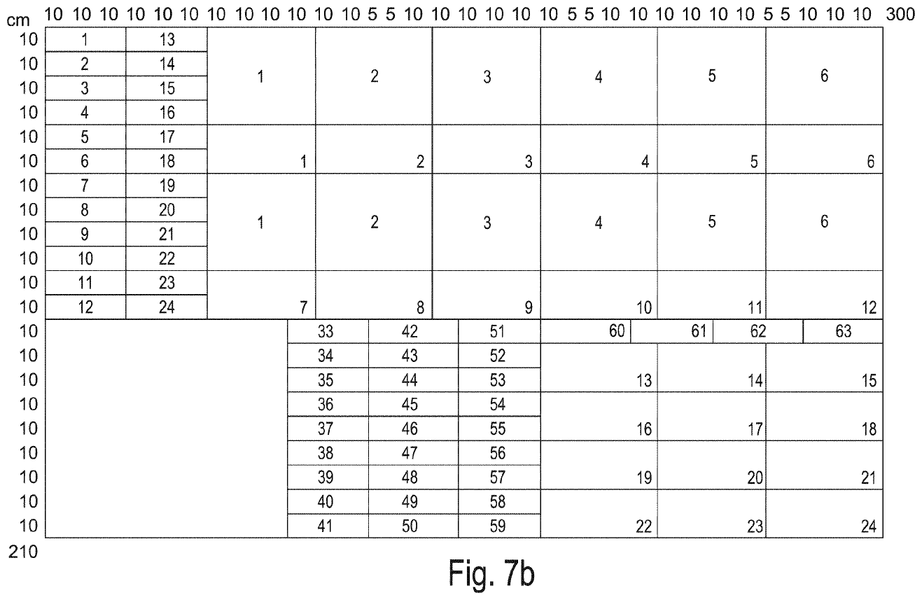

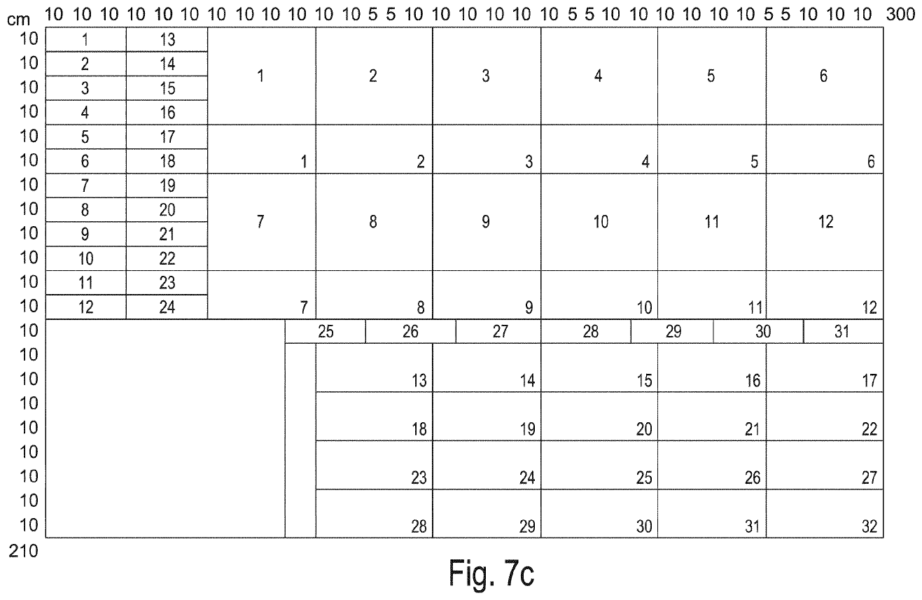

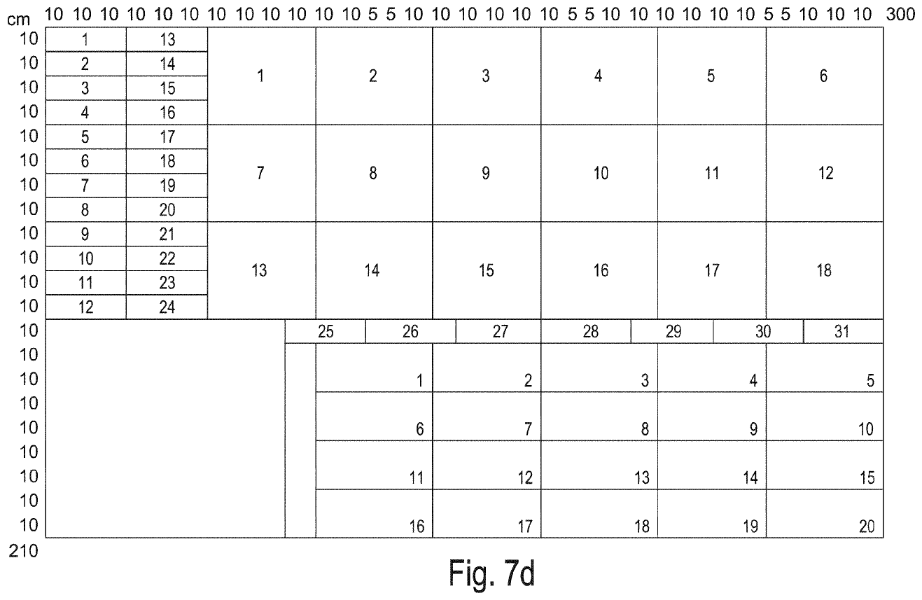

FIG. 6 shows a top view of a horizontal cross-sectional plane of a logistics vehicle with at least two shelves. According to the invention, the loading space of a depot facility 830 has the following interior configuration:
A storage unit (shelf unit) 1048 for the storage of parcels is located on each of the two long sides. For an exemplary design of the storage unit, see FIGS. 7a to 7d. A storage unit (shelving unit) that can be reconfigured at any time is also particularly advantageous, and an automatically configurable storage unit (shelving unit) is even more advantageous. The pusher unit 1045 and 1046 for moving parcels from the storage unit (shelf unit) 1048 to the transport unit 1041 is located between the respective storage unit (shelf unit) 1048 and the outer skin of the loading space of the depot facility 830. The transport unit 1041 transports the parcel 1044 along the guide rail 1047 to the handover gate 1049.

In the case of delivery of a parcel by a shipper via the handover gate 1049, the transport unit 1041 transports the parcel 1044 to a storage position of the storage unit 1041.

FIGS. 7a-d each show an advantageous compartment configuration of a shelving unit according to the invention. The storage units (shelving units), which are preferably located e.g. within depot facilities for the storage of parcels, but are also useful as a storage unit installed in a distribution center for the storage of parcels, as well as for the storage of objects in general, can have a fixed compartment configuration as in FIGS. 7a to 7d, e.g. in FIG. 7a with a total of 99 compartments in the layout with 63 compartments of size S (30 cm×10 cm×50 cm), 24 compartments of size M (35 cm×20 cm×50 cm) and 12 compartments of size L (35 cm×40 cm×50 cm), FIG. 7b with a total of 91 compartments in the division with 55 compartments of size S (30 cm×10 cm×50 cm), 24 compartments of size M (20 cm×40 cm×50 cm) and 12 compartments of size L (40 cm×40 cm×50 cm), FIG. 7c with a total of 75 compartments in the layout with 31 size S compartments (30 cm×10 cm×50 cm), 32 compartments of size M (20 cm×40 cm×50 cm) and 12 compartments of size L (40 cm×40 cm×50 cm) and FIG. 7d with a total of 69 compartments in the layout with 31 compartments of size S (30 cm×10 cm×50 cm), 20 compartments of size M (20 cm×40 cm×50 cm) and 18 compartments of size L (40 cm×40 cm×50 cm).

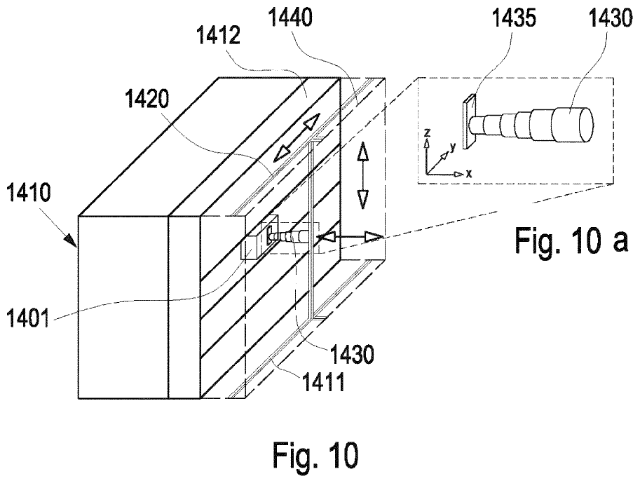

FIGS. 10 and 11 show an embodiment example of a storage unit 1410 according to the invention with a shelf unit and a pusher unit 1420 for moving parcels 1401 from a shelf 1412, 1512.

A guide rail 1420 or 1520 movably guides another guide rail along a predetermined path, in particular in the horizontal (y-direction) and/or vertical (z-direction) direction, so that a slider 1430 is mounted and can be moved along a complete side surface of the shelving unit.

A plunger 1435 is arranged extendably on the pusher 1430 and can be displaced in the X direction, so that the pusher 1430 can convey parcels 1401 out of the rack 1412, 1512, in particular onto a transport unit.

It is alternatively and/or additionally appropriate to equip the depot facilities 830, 5242 5243, 5321, 5322 with one or more gripper arms not shown for reasons of simplification.

The gripper arms are preferably arranged inside the logistics vehicles and are preferably long enough to perform a transport of parcels between storage positions of the depot facilities 830, 5242, 5243, 5321, 5322 and a handover gate 1601 of the depot facilities 830, 5242, 5243, 5321, 5322, preferably including a removal from the handover gate 1601 and a removal from storage positions of the depot facility.

It is also advantageous to equip the depot facilities 830, 5242, 5243, 5321, 5322 with at least one gripper arm, preferably similar to the gripper arms of the robots in the area of the chutes.

Using the gripper arm or arms in the depot facilities 830, 5242, 5243, 5321, 5322, individual, several or all of the following processing operations can be carried out and/or facilitated:
Transport of parcels between the handover gate 1601 and storage positions of the depot facility;
Carrying out and/or facilitating the storage of parcels in the storage positions of the depot facility;
Carrying out and/or facilitating the removal of parcels from the storage positions of the depot facility
Transport of parcels between the storage positions of the depot facility and the handover gate 1601.

Preferably, robot tools, preferably gripper systems, are attached to the gripper arms, in particular one or more suction grippers, also known as vacuum grippers. For example, the gripper systems known from DE 198 17 426 A1, in particular vacuum gripper systems, are adapted for this purpose. In particular, it is advantageous to use the measures described in this publication to monitor the gripping process using a force sensor. This enables corrections to be made if parcels are gripped incorrectly, as forces outside a tolerance range can be measured and used to vary the control of the gripping process.

Furthermore, it is appropriate to equip the gripper arms with one or more sensor modules, in particular at least one force sensor, in order to measure the force on the parcel to be lifted, in particular the parcels 026, 1044, 1667, 1698, which are preferably designed as returnable containers. Furthermore, the use of position sensors that are suitable for measuring a relative position or a distance between the parcel and the gripper or for determining the start and end points of a movement is advantageous.

Preferably, a flexible gripping device is used to pick up the parcels, which is shown, for example, in DE 20 2007 013 673 U1. This gripping device has a gripper with a multi-link frame, which is adapted for the present invention in such a way that better adaptation to variable dimensions (geometries) of the parcels is made possible.

### Transport Unit

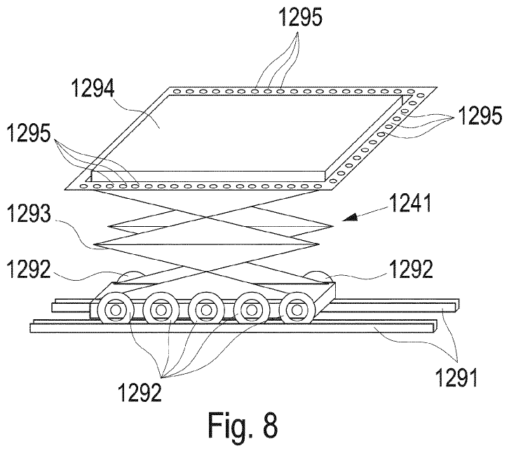

FIG. 8 shows a perspective view of a transport unit according to the invention. Transport units support the storage and removal of parcels to and from storage positions of storage units of depot facilities, as well as transport to and from a handover gate of the depot facility. The transport unit 1241 according to the invention is guided on rails 1291 by means of wheels 1292, which is useful, for example, for use within depot facilities and/or in the area of transfer units.

The transport unit 1241 has a height-adjustable device 1293, which is exemplarily designed in the form of a hinge. The height-adjustable device 1293 is used for the height-adjustable mounting of a transfer platform 1294. The transfer platform 1294 preferably has a conveyor belt for transporting parcels. The light barrier sensors 1295 are used to check whether, during handover of a parcel to and/or from the transfer platform 1294, the parcel is completely on the transfer platform 1294 and ready for transportation or has been completely transferred from the transfer platform 1294 to the unit being handed over.

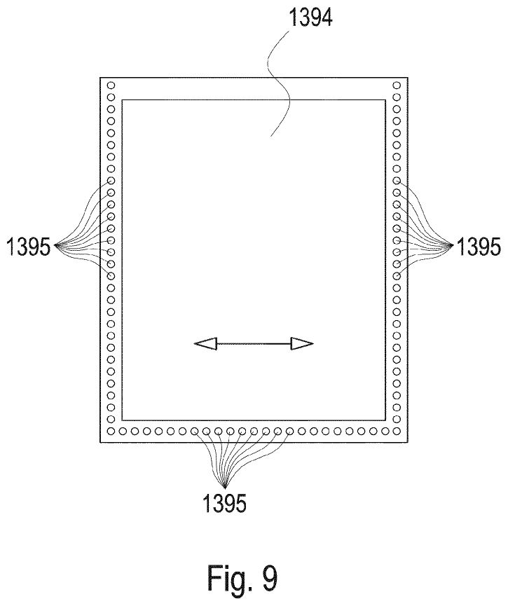

FIG. 9 shows a top view of a transport unit according to the invention; the transfer platform 1394 preferably has a conveyor belt for transporting parcels. The conveyor belt can be used to transfer a parcel, for example to the transfer platform and/or from the transfer platform to a storage position of a depot facility. The light barrier sensors 1395 are used to check whether, during handover of a parcel to and/or from the transfer platform 1394, the parcel is complete and ready for transportation on the transfer platform 1394 or has been completely transferred from the transfer platform 1394 to the unit being handed over.

In advantageous embodiments of the invention, at least individual ones of the depot facilities 830, 5242, 5243, 5321, 5322 are configured such that transport units move and/or are controlled therein such that they can perform and/or facilitate individual ones of several or all of the subsequent processing operations:
Transport of parcels between the handover gate 1601 and storage positions of the depot facility;
Carrying out and/or facilitating the storage of parcels in the storage positions of the depot facility;
Carrying out and/or facilitating the removal of parcels from the storage positions of the depot facility
Transport of parcels between the storage positions of the depot facility and the handover gate 1601.

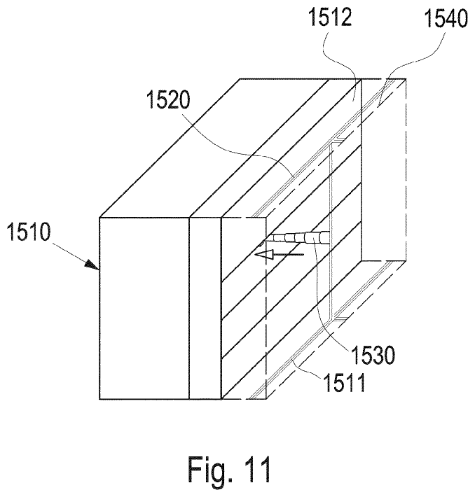

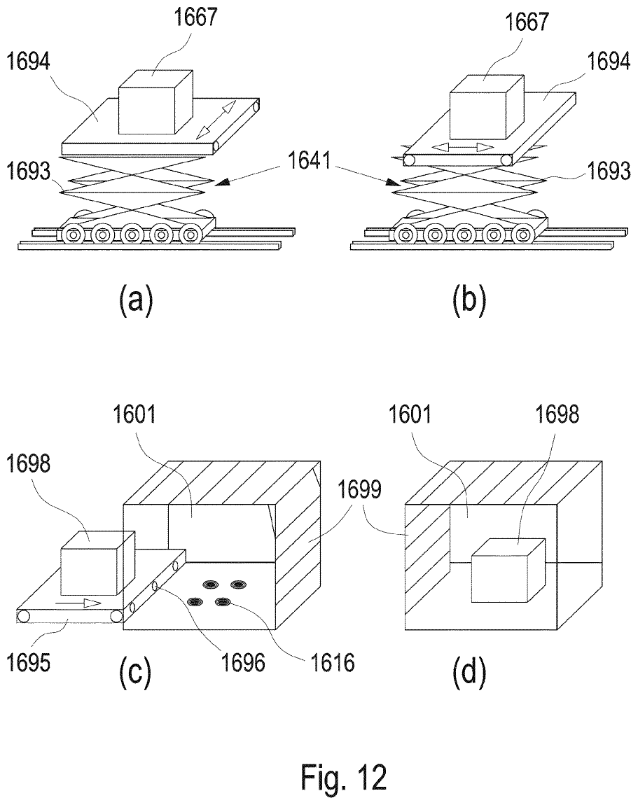

The transport unit 1641 according to the invention shown in FIGS. 12a and 12b is guided on rails, which is useful, for example, for use within depot facilities and/or in the area of transfer units.

The transport unit 1641 has a height-adjustable device 1693, which is exemplarily designed in the form of a hinge. The height-adjustable device 1693 is used for the height-adjustable mounting of a transfer platform 1694. The transfer platform 1694 preferably has a conveyor belt for transporting parcels, for example the parcel 1667 shown as an example in FIG. 12a. By means of the conveyor belt, a transfer of the parcel 1667, for example to the transfer platform and/or from the transfer platform to a storage position of a depot facility 830, 5242, 5243, 5321, 5322, can be supported.

The transfer platform 1694 is preferably rotatably mounted. This makes it easier, for example, for the transfer platform 1694 to pick up parcels from a conveyor belt of a transfer unit 5336 and/or—preferably after rotation of the transfer unit 5336—to transfer parcels to storage positions of storage units of the depot facilities.

The transport unit 1641 represents a preferred embodiment of the transport units 1041, 1241, 1641 shown in this application.

It is also possible to use the transport unit 1641 as a handover unit, which can transport parcels between the depot facility and individual handover points for handover of parcels to individual recipients and/or from individual depositors.

### Handover

For a handover of a goods object to the recipient, the parcel containing the goods object is first removed from the storage position of the depot facility, transferred to the transfer platform 1694 of the transport unit 1641 and then transported to the handover gate 1601. Alternatively, and/or additionally, the removal of parcels from the storage positions of the depot facility can be facilitated by using the pusher unit 1420 shown in FIGS. 10 and 11.

The handover of the at least one goods object contained in the parcel is preferably carried out by making it available to the recipient of the goods object for removal. Alternatively, the goods object can be transferred to a goods lock as a transfer lock.

FIGS. 12c and 12d show a principle representation of a handover of a goods object contained in a parcel 1698 in an area of a handover gate, which takes place during the handover to recipient 5160 and during local delivery 5190.

The handover gate 1601 is used for handover of parcels. The handover of parcels may involve the transfer of parcels from a storage unit of the depot facility to a recipient and/or the acceptance of parcels from shippers and the subsequent storage of the parcel in a storage unit in the depot facility.

After a recipient has removed a parcel, the handover gate 1601 closes again. The transport unit 1641 approaches the handover gate 1601 and uses the light barrier to check whether there is a parcel in the handover gate 1601. In the operating state of the handover gate 1601 shown in FIG. 12c, the light barrier 1696 reports that there is no longer a parcel in the handover gate. The handover has thus been successfully completed. Preferably, the depositor of the parcel, in particular the shipper of the parcel, now receives a notification of the successful handover, in particular the successful handover to the recipient of the parcel. If the parcel was not assigned to an individualized recipient-this is the case, for example, if the parcel is a goods object the depositor preferably receives a notification of the fact that the parcel has been successfully handed over.

If a parcel or other item is in the handover gate 1601, the depot facility and/or the system checks whether the recipient of the parcel is still in the immediate vicinity of the depot facility. If this is the case, the recipient is contacted immediately via the app and asked whether he would like to remove his parcel. If the recipient does not respond or says no, the parcel is transported by a transport unit and/or a gripper arm back to one of the storage positions of the depot facility, preferably to the storage position from which the parcel was removed.

Returning the parcel to one of the storage positions of the depot facility is advantageous even if the recipient is no longer in the immediate vicinity of the depot facility.

In a preferred embodiment, the system preferably informs the shipper in parallel so that the shipper can also contact the recipient and/or assign the parcel to another recipient.

If the recipient is still in the immediate vicinity of the depot facility and requests a new handover, the handover unit will open after the recipient has been authenticated accordingly.

### Reusable Containers

FIG. 13 shows a particularly preferred parcel from the prior art for handover. It shows an exemplary reusable container from the patent application with publication number EP 3 865 417 A1. Such or a similar reusable container is treated as a parcel for the purposes of this application and is particularly suitable for carrying out the method in FIG. 1.

### Assignment of Parcels to Recipients Based on Recipient Attributes

While in conventional parcel processing systems, parcel processing operations provide for a transport of parcels from a fixed shipper to one or more predetermined recipients-this is also possible with the processing operations presented in the present application-the processing operations presented as advantageous in the present application allow a flexible assignment of parcels to recipients and/or handover points, whereby it is particularly advantageous to flexibly assign a final recipient and/or a final handover point, which can be selected as the final recipient in particular from the joint optimized handover points and individual handover points for an individual recipient shown in the present application.

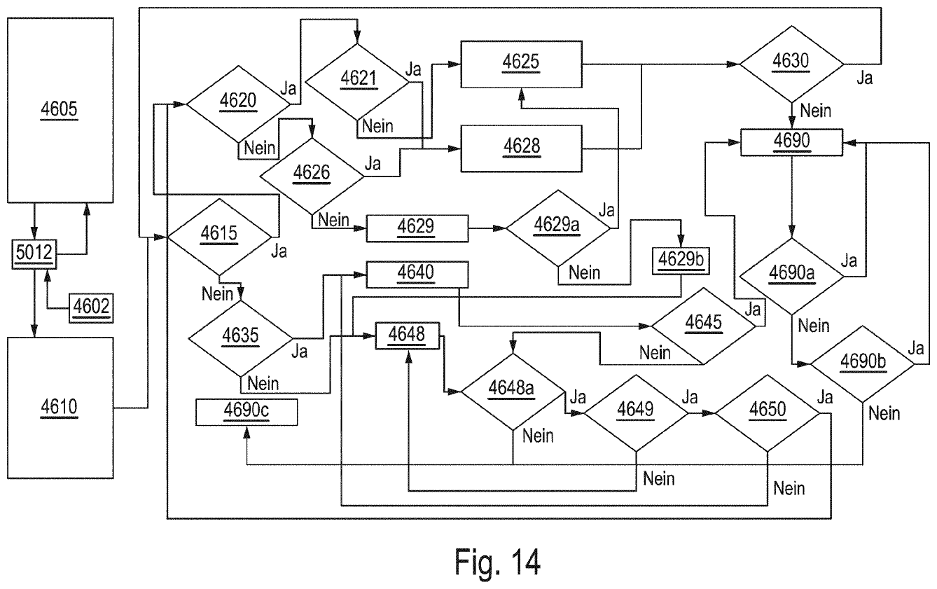

FIG. 14 shows a schematic representation of a particularly preferred use of parcel identification characteristics and recipient attributes in a method for handover of a plurality of parcels from a plurality of shippers to a plurality of recipients by a logistics system, in particular where the logistics system performs at least one processing operation on the parcels using a parcel identification code assigned to each of the parcels.

Preferably, the recipient attributes disclosed in this application serve to identify a respective intended recipient of a parcel, whereby it is also advantageous in this embodiment of the invention to assign to the respective parcels changing proportions of fixed recipient attributes and variable recipient attributes assigned to them in each case, whereby individual, several or all information that can identify the recipient can be used as recipient attributes, so that various assignments of a parcel to a recipient are possible, in particular as shown below by way of example with reference to FIG. 14:
a fixed recipient when the parcel is posted,
a recipient selected after the parcel has been posted,
a final recipient definable during a stay of the parcel in a depot facility, in particular
   a member of a specific user group, in particular a prioritized user group;
   a recipient who is willing to pay a designated fee for the parcel,
   a definable buyer and
   any buyer, especially in the case of a direct sale.

In the state of the art, shippers must select a parcel identification code for each parcel from a closed number range specified by a logistics service provider, specify the destination address of the parcel in full and apply both the parcel identification code and the information on the destination address in one or more codes specified by the logistics service provider (e.g. barcodes, data matrix codes or 2D codes) on a label designed according to the logistics service provider's specifications. Other information, e.g., about special services such as priority processing or the collection of money on handover or delivery, must also be applied to the label according to fixed rules. A logistics system that can be used for this purpose can be designed more flexibly:
Original parcel identification characteristics that can be freely selected by the shipper, such as customer number, order number or invoice number, can be used as individual characteristics or in a combination of at least two characteristics as a parcel identification code or as components of the parcel identification code, and do not have to be applied to a label in the form of special codes, for example-any characteristics, in particular alphanumeric characteristics, that are permanently linked to the parcel and communicated in pre-shipment data are sufficient for the individual parcels after a standard instruction for several parcels has been transmitted to the logistics system.
A destination address (in particular the address of a recipient, a logistical node, a joint optimized handover point or an individual handover point) does not have to be specified in full, including zip code, city, street and house number, either in the pre-sending data or on the parcel. Preferably, the shipper either specifies a final recipient in the data record and/or on the parcel by providing suitable information (e.g., e-mail address or cell phone number) or the shipper initially only specifies individual recipient address attributes that enable the parcel to be transported to a specific processing unit and specifies the final recipient later.
Other information, e.g., about special services such as priority processing or collection of money on handover or delivery, can be specified in the pre-shipment data and/or in any form on the parcel that can be processed by the logistics system.

Preferably, the pre-transmission data for a parcel are components of a digital twin of the parcel and allow the creation of a digital twin of the parcel.

It is advantageous for shippers of the parcels to define rule instructions for several parcels, in particular for all of the shipper's parcels or for all of the shipper's parcels that are delivered to the logistics system within a processing period, in a method step 4602, and to transmit these rule instructions to the logistics system. The rule instructions determine which original parcel identification characteristic physically connected to the parcel and readable or which original parcel identification characteristics physically connected to the parcel and readable of the individual parcels delivered by the shipper are to be taken into account to form the parcel identification code assigned to each individual parcel.

The original parcel identification characteristics of the individual parcels to be delivered by the shipper, which are associated with the individual parcels and can be read out, are preferably transmitted by the shipper to the logistics system in a method step 4605 as data to be sent in advance of the shipment. The data to be transmitted in step 4605 preferably also includes information from the shipper as to whether and, if so, up to what time period the shipper releases payment of any fee for interim storage of the parcel during transportation.

In the method step 4610, the package identification code of an individual parcel is generated. The packet identification code of the parcel is generated taking into account at least one original parcel identification characteristic of the parcel, in particular at least two original parcel identification characteristics of the parcel.

It is advantageous to perform the method step 4610 after the method steps 4602 and 4605: In method step 4602, a control component of the logistics system, in particular the control component 5012 explained with reference to FIG. 5, receives the rule instructions from the shippers via an interface for receiving rule instructions from the shippers, the rule instructions from the respective shippers determining which original parcel identification characteristic physically connected to the parcel and readable or which original parcel identification characteristics physically connected to the parcel and readable of the individual parcels delivered by the shipper is or are taken into account to form the respective parcel identification code assigned to the individual parcels. In a later method step 4605, the control component of the logistics system further receives information from the shippers on parcels to be delivered, wherein the information for an individual one of the parcels contains at least one original parcel identification characteristic of the parcel corresponding to the rule instruction, so that in method step 4610 the parcel identification code is formed taking into account the original parcel identification characteristic or characteristics. In at least one processing operation of the parcel, the presence of the original parcel identification characteristic or characteristics is determined, so that identification of the parcel is performed, so that at least one subsequent processing operation of the parcel is performed taking into account the parcel identification code.

Parcels according to the state of the art and goods objects according to the state of the art—such as the parcel shown as an example in FIG. 13, which can be used as a reusable container—can also be handled as parcels according to the invention, taking into account the processing operations shown.

It is appropriate that the parcel identification code of a parcel is stored as a primary parcel identification characteristic, that at least one secondary parcel identification characteristic different from the primary parcel identification characteristic is assigned to the parcel, and that at least one processing operation of the parcel is performed using the secondary parcel identification characteristic. This includes individual, several or all of the method steps 4615 ﬀ as particularly preferred embodiments.

An advantageous further development of the invention provides that further information is assigned to the parcels as machine-readable data, in particular by using digital twins. The assignment of machine-readable data, in particular the digital twins, takes place in particular in method step 4610. An example of the further information includes dimensions, in particular the spatial dimension of the parcel and/or the weight of the parcel, due date/time, penalties for late delivery, delivery costs, depositor and recipient information, material, fragility and parameters of the required transportation of the parcel, for example a refrigerated truck for goods that require refrigeration.

One particularly important piece of information is whether the parcel is a returnable container.

The invention includes embodiments in which parcels are handed over to recipients, in particular by means of local logistics at or near their place of delivery, as well as embodiments in which at least some of the parcels are transported and/or processed within the logistics system by means of a controlled transport route and/or sorting route after the parcel identification code has been determined and/or ascertained.

The processing of the parcels in process steps 4620 ﬀ. is controlled taking into account the verification step 4615.

In the verification step 4615, it is determined whether the shipper of the parcel has determined a final recipient of the parcel. The transmission of a potential final recipient of the parcel is performed, for example, in the method step 4605 as part of the pre-transmission data. It is appropriate to specify the final recipient by at least one of the following information:
Email address;
Cell phone number,
Full postal address;
Tax identification number;
Pension insurance number
Identity card number;
Credit card number;
IBAN.

It is particularly advantageous to determine the final recipient of the parcel at a later time, so that the verification step 4615 can be repeated if necessary. By using the processing steps illustrated in this application, in particular the processing steps illustrated with reference to FIG. 14, it is possible to select and, if necessary, change the final recipient of the parcel until immediately before handover of the parcel to the final recipient.

The process steps described in this application may in particular be processing steps or verification steps.

If it is determined in the verification step 4615 that a final recipient of the parcel has been determined by the shipper, a verification step 4620 checks whether the final recipient is stored in a recipient database 5032 of the logistics system in order to take the recipient's delivery preferences and/or locations into account accordingly.

In an advantageous embodiment, the consideration of recipients as final recipients for the final handover of the parcel is carried out by using at least one depot facility 830, 5242, 5243, 5321, 5322. In particular, if the depot facility has sufficient information to authorize the final recipient, it can affect the final handover to the final recipient in a method step 4690.

If it is determined in the verification step 4620 that the recipient of the parcel is stored in the logistics system and/or a processing unit of the logistics system, in particular in a recipient database 5032 with at least one delivery preference, a verification step 4621 may first check whether there is an instruction from the shipper of the parcel regarding a restriction of delivery preferences of the recipient of the parcel. If there is no instruction from the shipper to restrict the selection of delivery preferences of the recipient, the parcel is processed in method step 4625, which may consist of several individual processing steps, in accordance with the transmitted and/or stored delivery preferences of the recipient.

In method step 4630, a check is made to determine whether an instruction from the shipper to change the final recipient has been received. If there is an instruction from the shipper to change the final recipient, further control of the processing of the parcels is carried out taking into account the verification operations and/or processing operations shown from verification step 4615. If no instruction is present, the parcel is provided in process step 4690 by a final processing unit, for example a depot facility or a handover unit for handover to the recipient. In particular, after successfully completed authentication, for example by means of a user app 5021, 5022 or a user component 5351, a user is authorized as the final recipient, in particular to remove a parcel from the depot facility.

At periodic intervals, e.g., at the end of each day, a verification step 4690a follows, in which it is checked whether the parcel is still in the depot facility due to a handover that has not taken place to the final recipient. If this is the case, verification step 4690b follows: the shipper or the recipient is asked whether he/she has authorized payment of any fee for further storage in the depot facility. If this is the case, the parcel remains in the depot facility until it is handed over in accordance with process step 4690. If there is no such release, the parcel is returned to the shipper in accordance with process step 4690c.

If it is determined in the verification step 4620 that the final recipient previously communicated in the method step 4615 is not stored in the recipient database 5032 of the logistics system, a further verification step 4626 checks whether the parcel itself, in particular in the form of information physically connected to the parcel (in particular “printed on”; RFID transponder) or in the form of supplementary information about the parcel, for example as part of a digital twin of the parcel, has a complete address or a complete address can be determined using the supplementary information.

If it is determined in verification step 4626 that the complete recipient address can be determined, the parcel is processed in process step 4628 according to the shipper's address information.

If no complete recipient address can be determined in the verification step 4626, an intermediate storage of the parcel is performed in the method step 4629. Then, using recipient attributes that enable the recipient to be contacted, a query is made to the recipient regarding his delivery preferences. Recipient attributes that enable the recipient to be contacted are, for example, e-mail address or mobile phone number.

In verification step 4629a, the logistics system checks whether the recipient has transmitted corresponding delivery preferences. If this is the case, the parcel is processed in processing step 4625 according to the recipient's delivery preferences. If the recipient does not transmit any delivery preferences, the shipper is contacted in process step 4629b and the shipment is temporarily stored in a processing unit in accordance with process step 4648.

It is appropriate for a verification step 4648a to check whether the shipper has authorized payment of any fee to be paid for temporary storage of the parcel in the processing unit.

If the shipper does not issue this release or if a period of time approved by the shipper for temporary storage of the parcel has expired, the parcel is returned to the shipper in process step 4690c.

If the shipper has granted this release and the released period for the temporary storage of the parcel has not been exceeded, a check step 4649 checks whether the shipper has transmitted additional and/or new recipient address attributes.

If the shipper has not transmitted any further recipient address attributes that were not previously available when the verification step 4649 was performed, the parcel continues to be temporarily stored in the processing unit in the processing operation 4648 until the shipper transmits additional recipient address attributes or the period of time released by the shipper for temporary storage of the parcel has expired.

It is appropriate for a verification step 4648a to check whether the shipper has authorized payment of any fee to be paid for temporary storage of the parcel in the processing unit.

If the shipper has transmitted the further recipient address attributes, a verification step 4650 checks whether the transmitted further recipient address attributes enable the final recipient to be identified.

If the other recipient address attributes transmitted allow the final recipient to be identified, the system branches to verification step 4620.

If the transmitted further recipient address attributes do not allow sufficient identification of the final recipient, the system branches to process step 4640 with a transport to the processing unit determined by the supplemented recipient address attributes.

Following processing step 4640, a verification step 4645 is performed, in which a check is performed to determine whether the shipper has authorized a direct sale of the parcel. In the event that the shipper has authorized the direct sale of the parcel, a handover of the parcel to a buyer of the parcel as the final recipient takes place in processing step 4690.

Preferably, the identification of the final recipient includes not only the identification of uniquely identifiable authorized final recipients as in verification step 4620, but also final recipients that meet at least one prerequisite for handover of the parcel to them. For example, a prerequisite or further prerequisite for handover of the parcel is payment of a monetary amount. Thus, in process step 4690, it is also possible to consider as final recipients for the final handover of the parcel recipients who may pay an amount of money immediately before the final handover of the parcel or who have proven that they belong to a user group and are otherwise not identifiable.

At periodic intervals, e.g., at the end of each day, the verification steps 4690a and 4690b follow, in which it is checked whether the parcel is still in the depot facility due to handover to the final recipient not having taken place and, in this case, whether the shipper or recipient has issued a release for payment of any fee. If this is the case, the parcel remains in the depot facility until handover takes place in accordance with process step 4690. If there is no such release, the parcel is returned to the shipper in accordance with process step 4690c.

If it is determined in verification step 4645 that the shipper has not authorized a direct sale of the parcel, a further verification step 4648a is performed, in which it is checked whether the shipper has issued a release for payment of any fee to be paid for the temporary storage of the parcel in the processing unit.

If the shipper does not issue this release, the parcel is returned to the shipper in process step 4690c.

If the shipper grants this release, verification step 4649 follows, in which it is checked whether the shipper has transmitted any other recipient address attributes that were not previously available.

If the shipper has not transmitted any further recipient address attributes that were not previously available when the verification step 4649 was performed, the parcel is temporarily stored in the processing unit in a processing operation 4648 until the shipper transmits additional recipient address attributes or a period of time approved by the shipper for temporary storage of the parcel has expired. Again, verification step 4648a checks whether the shipper has released any charges for further temporary storage. If this is not the case, the parcel is returned in accordance with process step 4690c.

If the shipper has transmitted the further recipient address attributes, a verification step 4650 checks whether the transmitted further recipient address attributes enable the final recipient to be identified.

If the other recipient address attributes transmitted allow the final recipient to be identified, the system branches to verification step 4620.

If the transmitted further recipient address attributes do not enable identification of the final recipient, the processing step 4640 takes place again, which may consist of several individual processing steps, i.e. further transport and/or other processing of the parcel until the parcel has reached a node of the logistics system, in particular a processing unit, which is determined by the further recipient address attributes. The parcel is then processed in accordance with the method steps 4645 to 4690 already described.

The verification step 4615 branches to a further verification step 4635 as an alternative to the processing step 4620 in the event that the shipper has not specified a final recipient, in particular if it takes place following the processing step 4610.

Verification step 4635 checks whether the shipper has assigned recipient address attributes to the parcel, but not a final recipient.

If the shipper has assigned recipient address attributes to the parcel, further transportation and/or other processing of the parcel takes place in a processing step 4640, which may consist of several individual processing steps, until the parcel has reached a node of the logistics system, in particular a processing unit, which is determined by the recipient address attributes. Following processing step 4640, the further process steps described above take place.

If it is determined in the verification step 4635 that the shipper has not assigned any recipient address attributes to the parcel, the parcel continues to be temporarily stored in the processing unit in a processing operation 4648 until the shipper transmits additional recipient address attributes or the period of time released by the shipper for temporary storage of the parcel has expired.

Following processing step 4648, the further process steps described above are carried out.

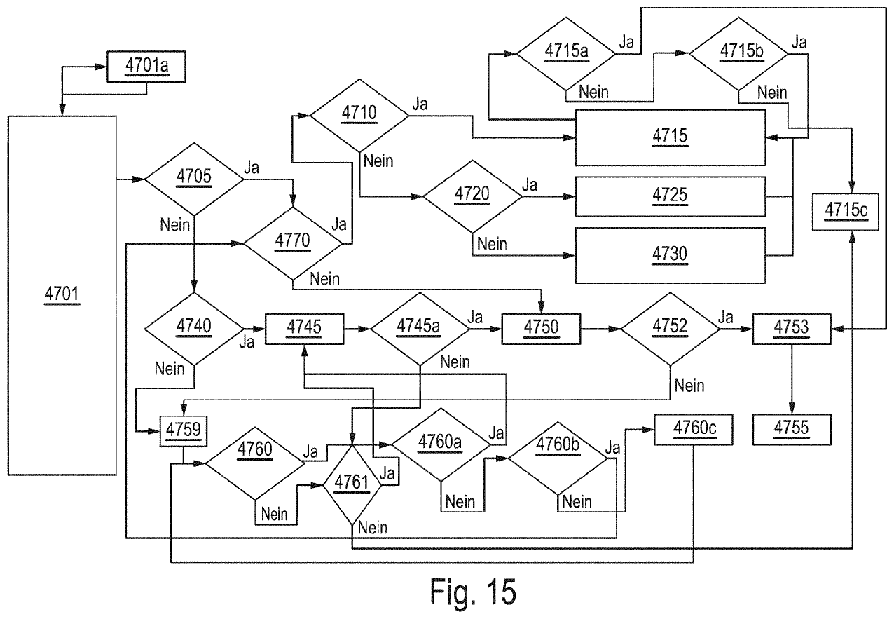

FIG. 15 shows procedural steps for handover of a parcel to a customer as the final recipient. In particular, FIG. 15 shows process steps for the local posting and handover of a parcel at a location of a depot facility or in the area of influence of the depot facility. In particular, this is an implementation of local logistics in which at least some of the parcels are handed over to recipients at their place of posting or in the vicinity of the place of posting. The recipients are in particular buyers of goods and/or services. The services include, in particular, processing the parcels or the contents of the parcels, for example by cleaning or repairing items, including, for example, parcels that can be used as reusable containers.

It is possible that the depositor delivers to a handover unit instead of the depot facility, or that the handover to the recipient takes place via a handover unit.

The various exemplary assignments of a parcel to a recipient shown in FIG. 15 also show in particular an advantageous use of the recipient attributes disclosed in this application for identifying a respective intended recipient of a parcel, it also being appropriate in this embodiment to assign to the respective parcels changing proportions of fixed recipient attributes and variable recipient attributes assigned to them in each case, it being possible to use individual, several or all of the information that can identify the recipient as recipient attributes, so that various assignments of a parcel to a recipient are possible, in particular:
a fixed recipient when the parcel is posted,
a recipient selected after the parcel has been posted,
a final recipient definable during a stay of the parcel in a depot facility, in particular
   a member of a specific user group, in particular a prioritized user group;
   a recipient who is willing to pay a designated fee for the parcel,
   a definable buyer and
   any buyer, especially in the case of a direct sale.

In a method step 4701, a delivery of one or more parcels is prepared and carried out. In particular, the parcel is deposited directly at the depot facility or, for example, via a handover unit in the area of influence of a depot facility.

In process step 4701, the delivery of the parcel to the logistics system, in particular to a depot facility of the logistics system, is prepared. Preparation of the delivery includes, in particular, recording the following information:
Identification of the consignor,
Recording the dimensions of the parcel and
Indication of a maximum storage period, the maximum storage period depending in particular on a release for payment of any fee for storage of the parcel, in particular in a depot facility.

In particular, the storage period denotes a period of time for a storage of the parcel, so that the storage period is also a period of time disclosed in the present application, in particular a period of time as shown in FIG. 14.

A preferred preparation for depositing the parcel is characterized in that the depositor, in particular the local depositor opens a user app 4701a, 5021, 5022 preferably with the characteristics described in the paragraph 5021, 5022 and enters consignment data or captures a code, which may for example contain consignment data and/or information for paying a fee for the deposit. For example, the depositor may enter:
A) at least one parcel identification characteristic for identifying the parcel, in particular an original parcel identification characteristic or
B) at least two original parcel identification characteristics to identify the parcel or
C) no specific data on the respective parcel,
D) a recipient/collector of the parcel,
E) a fee to be paid.

It is particularly advantageous if the user app 4701a, 5021, 5022 supports a detection of dimensions of the parcel. In particular, if the user app 4701a, 5021, 5022 is installed on a mobile user unit, for example a smartphone, a smartwatch or a smartglass, it is advantageous for the mobile user unit to record at least one dimension of the parcel and to transmit these recorded dimensions to a processing unit of the logistics system, in particular the depot facility or a handover unit located in the area of influence of a depot facility.

The determination of parcel identification characteristics and/or the determination of a parcel identification code is possible, but not necessary, particularly in embodiments of local logistics in which the parcel is not transported between different processing units, but remains in a depot facility in particular.

If a parcel identification code is to be recorded and/or created, in particular in order to realize options for transporting the parcel to further processing units, it is advantageous that the user app 4701a, 5021, 5022 of the consignor or a processing unit of the logistics system is set up in such a way that it can create a parcel identification code identifying the parcel.

Especially when the parcel is deposited directly at a depot facility or in the area of influence of a depot facility, it is particularly advantageous if the depositor scans the respective parcel in variants A), B) and C) and records parcel identification characteristics, in particular the parcel identification code. Preferably, at least one parcel identification characteristic, in particular at least one dimension of the parcel, is recorded by scanning the parcel.

The parcels can be scanned, for example, using the depositor's user app 4701a, 5021, 5022 or via a scanning device at the depot facility.

It is also possible to set a purchase price for the parcel or to define a calculation rule for the purchase price.

An optionally feasible, but not necessary, further development of the invention to prevent tampering is that as soon as the parcel can no longer be physically removed from the depot facility (in particular by closing a flap of the handover gate), the parcel is photographed or scanned by one or more suitable devices of the depot facility in order to document the transfer of risk. Alternatively, the depositor receives a confirmation of delivery and/or storage after “contact” of the parcel with the transport unit or after storage in a storage position of the depot facility.

Following processing step 4701, a verification step 4705 determines whether the depositor has specified a final recipient, in particular a final buyer. In the event that the depositor has specified a final recipient of the parcel, a verification step 4770 checks whether the final recipient, in particular the buyer, has already paid for the goods. If this is not the case, the parcel is processed in accordance with the process step 4750 described later and the subsequent process steps. If the verification step 4770 shows that the final recipient, in particular the buyer, has paid for the goods, the control component 5012 of the logistics system checks in a subsequent verification step 4710 whether the specified final recipient, in particular the buyer of the goods, is located in a recipient database.

If the specified final recipient, in particular the buyer of the goods, is in the recipient database, the parcel is temporarily stored in a process step 4715 and made available for handover to the specified final recipient, in particular the buyer of the goods.

The parcel is provided in the method step 4715 in particular by temporarily storing and providing the parcel in a depot facility, wherein in an appropriate embodiment the depot facility is the same depot facility in which the depositor has previously delivered the parcel.

Alternatively, the deposited parcel can also be transported by the logistics service provider (manually or by a handover unit) from the depot facility at which the depositor has deposited the parcel to another depot facility and then handed over to the final recipient by this depot facility.

Processing step 4715 is followed by a verification step 4715a: This involves checking whether the final recipient initiates a handover of the parcel during the maximum storage period of the parcel, in particular at a depot facility or in the area of influence of the depot facility.

If the final recipient initiates the handover of the parcel during the maximum storage period of the parcel, a processing step 4753 takes place: The handover to the final recipient is authorized and carried out.

If it is determined in verification step 4715a that the final recipient of the parcel has not initiated a handover of the parcel or has not visited the depot facility during the maximum storage period, a verification step 4715b checks whether the depositor or the final recipient is willing to pay a fee for further storage or has paid a fee for further storage of the parcel in the meantime.

If it is determined in verification step 4715b that no one, in particular neither the depositor of the parcel nor the final recipient of the parcel, is willing to pay a fee for further storage or has paid a fee for further storage of the parcel in the meantime, the depositor of the parcel is requested in accordance with process step 4715c to remove the parcel-in particular to remove it from the depot facility. Alternatively, the parcel is returned to the depositor, possibly for an additional fee.

In the event that it is determined in verification step 4710 that no entry corresponding to the final recipient exists in a recipient database of the logistics system, a further verification step 4720 checks whether the depositor has provided contact details of the final recipient.

In the event that the depositor has provided contact details (e.g., cell phone number, e-mail address) of the final recipient, it is appropriate for the logistics system to send an authentication code and/or authorization code directly to the final recipient in a processing step 4725.

Following processing step 4725, it is appropriate for the logistics system to temporarily store the parcel in a storage unit, in particular a depot facility, in process step 4715. Further processing of the parcel then takes place according to the process steps 4715a, 4715b, 4715c and 4753 described above.

In the event that it is determined in the verification step 4720 that the depositor has not provided any contact data for the final recipient or that it is not possible to transmit the authentication code and/or the authorization code to the final recipient via the provided contact data of the final recipient, for example due to an inaccuracy in the contact data of the final recipient, the authentication code and/or the authorization code is transmitted to the depositor in a process step 4730, which the depositor can transmit to the final purchaser as the final recipient or to another final recipient, for example. The final recipient can use the authentication code and/or the authorization code to effect a handover of the parcel at the depot facility in process step 4753.

If it is determined in verification step 4705 that the depositor has not specified a final recipient, it is determined in verification step 4740 whether a sale of the parcel at a price specified by the depositor to any buyer as a direct sale is possible.

Direct selling means in particular that a stored good or parcel has not yet been assigned a final recipient and that anyone can purchase and remove the goods upon payment of a determinable sales price (fee).

If a direct sale of the parcel is possible, the previously stored parcel is temporarily stored in a storage unit, in particular in the depot facility, in a processing step 4745.

Subsequently, a verification step 4745a checks whether, during the maximum storage period, a potential buyer as final recipient arrives at a location of a depot facility or within the depot facility's sphere of influence and intends to purchase the parcel.

In processing step 4750, the potential buyer is provided with at least one payment option, for example by entering a code or monetary information, for example via PayPal, Apple Pay.

Monetary value information is retrieved, for example, from a loading point, wherein in a simple and equally appropriate embodiment a random number and a payment identification number are formed in the loading point, wherein a seller receives the character string as a monetary value amount for a payment and wherein the seller further submits the character string to an eCommerce center to verify its validity and to initiate a payment. The payment processes shown in this application are carried out, for example, by means of Near Field Communication (NFC), in particular in combination with a wallet and/or in order to make payments in apps or browsers intended for this purpose. For example, a randomly generated pseudo credit card number stored in a security module can be used for a payment transaction. It is appropriate that a device identification number of a device on which a user app 5021, 5022 is installed or a user component 5351 of a user, in particular the recipient of the parcel, is transmitted to the seller during payment transactions. In a catchment area of a depot facility, this is preferably done by means of near-field communication. However, the device identification number and/or the monetary information can also be transmitted via an intranet or the Internet. The seller transmits the monetary information, for example this number, to a payment service provider who checks whether a payment release can be made using this information and then transmits the payment release to the seller and/or the logistics system. Once the payment release has been received, a handover of the parcel for which the payment was to be made is released and authorized in the presence of the recipient.

Following processing step 4750, verification step 4752 checks whether payment has been made. In the event that it is determined in the verification step 4752 that payment has been made, in the execution step 4753 a handover of the parcel to the buyer as the final recipient is authorized directly at the depot facility or, for example, via a handover unit in the area of influence of the depot facility, in the process step 4755 the depositor is informed and he receives the consideration (the sales price), for example by bank transfer or by a credit note in a credit note system.

If it is determined in verification step 4752 that no payment has been made, process step 4745 and the subsequent process steps are run through again.

If it is determined in verification step 4745a that the maximum storage period has expired without a potential buyer/final recipient having purchased the parcel, a verification step 4761 takes place, in which it is checked whether the shipper or depositor has issued a release for payment of any fee for an extended storage period. Further processing of the parcel is then based on the process steps 4760, 4760a, 4760b and 4760c described below.

If it is determined in the verification step 4740 that no direct sale of the parcel is possible because the depositor has not entered an amount for which the parcel can be sold, the parcel is temporarily stored in a processing step 4759, in particular by storing it in the depot facility.

In a verification step 4760, the system checks at intervals during the maximum storage period whether the depositor has transmitted new information relevant for further processing of the parcel:

If it is determined in verification step 4760 that the depositor has not transmitted any new information relevant for the further processing of the parcel to the logistics system and/or the depot facility during the maximum storage period, verification step 4761 is performed.

Verification step 4761 checks whether the depositor has authorized the payment of any fee for extending the storage period of the parcel.

If the depositor has approved payment of any fee for extending the storage period of the parcel, the parcel will be stored further in accordance with processing step 4759.

If the depositor is not willing to pay a fee for further storage, the depositor will be asked to collect the parcel in processing step 4715c or it will be returned to them if necessary. Preferably, an additional fee will be charged for returning the parcel to the depositor.

If it is determined in verification step 4760 that the depositor has transmitted new information relevant for the further processing of the parcel to the logistics system and/or the depot facility during the maximum storage period, verification step 4760a is performed immediately. The system checks whether the new information from the consignor enables a direct sale. If this is the case, further processing of the parcel is based on the process steps 4745, 4745a, 4750, 4752, 4753 and 4755 described above.

If it is determined in verification step 4760a that the new information from the consignor does not enable a direct sale, verification step 4760b is carried out immediately afterwards. This checks whether the depositor has specified a final recipient. If this is the case, the parcel is processed further in accordance with the process step 4770 described above and the subsequent process steps.

If it is determined in verification step 4760b that the depositor has not indicated a final recipient, the new information relevant for further processing of the parcel preferably includes information about an extended storage period. After receipt of this information in process step 4760c, further processing of the parcel is carried out in accordance with the process step 4760 already described and the subsequent further process steps.

The embodiments shown here are only examples of the present invention and should therefore not be understood to be limiting. Alternative embodiments contemplated by the skilled person are equally encompassed by the scope of protection of the present invention.

What is claimed is:

1. Method for handover of a plurality of goods objects to a plurality of recipients, wherein the goods objects are stored and/or transported in parcels and are transferred in the parcels to a depot facility and then stored in the depot facility, characterized in that, in the case of at least some of the parcels, at least one goods object located in the parcel is made available to a recipient for removal in each case, so that a handover of the goods object is carried out as a first handover operation, but a handover of the parcel is prevented, so that the parcel which is not handed over to the recipient of the goods object remains in the depot facility, in that the parcel is filled with at least one further goods object after the first handover operation and is used for a further handover operation for the further goods object to a further recipient.

2. Method according to claim 1, characterized in that the first recipient can make a selection for returning after receiving the goods object and that the goods object is placed in a parcel and stored using the depot facility.

3. Method according to one of claims 1 or 2, characterized in that handling of the parcel up to the first transfer operation takes place taking into account a first recipient attribute, and in that further handling of the parcel after the first transfer operation and/or after loading of the parcel with the goods object takes place taking into account a second recipient attribute.

4. Method according to one of the preceding claims, characterized in that, before or during at least one of the handover operations, a decision process takes place as to whether a parcel belongs to the part of the parcels in which at least one goods object located in the parcel is made available to a recipient for removal, but a handover of the parcel is prevented, so that the parcel is not handed over to the recipient, or whether the parcel belongs to a further part of parcels which are handed over to the respective recipient in the handover operation.

5. The method according to claim 4, characterized in that the decision process is carried out as a function of at least one property of the parcel.

6. The method according to claim 5, characterized in that at least one of the following characteristics of the parcel is preferably taken into account in the decision-making process:
Reusability of the parcel;
Openness of the parcel;
Possibility to open the parcel;
Reclosability of the parcel;
Labeling of the parcel.

7. The method according to any one of claims 4 to 6, characterized in that the decision process is carried out in dependence on an instruction of at least one of the following entities:
of the shipper of the parcel;
of the recipient of the parcel;
an operator of the logistics system.

8. Method according to any one of claims 4 to 7, characterized in that the decision-making process takes place in dependence on a payment of any fee for a handover of the parcel to the recipient.

9. Method for handing over a plurality of goods objects to a plurality of recipients, the goods objects being stored and/or transported in parcels, in particular according to one of the preceding claims, characterized in that, in at least some of the parcels, in each case at least one goods object located in the parcel is made available to a recipient for removal, so that a handover of the goods object is carried out as the first handover operation, in that at least individual parcels are designed as reusable containers which are provided with individual identifiers, and in that the reusable containers are assigned parcel identification codes as a function of further information.

10. Method according to claim 9, characterized in that a first parcel identification code is assigned to the returnable container marked with the individual identifier until a first handover of a goods object contained therein to a first recipient, and in that a new parcel identification code is assigned to the returnable container provided with the individual identifier after it has been filled with at least one further goods object, in particular in such a way that the returnable container is processed by a logistics system as a further parcel without the returnable containers having to be marked again for further processing operations within the logistics system.

11. Handover device for handing over goods objects contained in parcels, characterized in that the handover device is set up in such a way that, for at least some of the parcels, at least one goods object contained in the parcel can be made available to a first recipient for removal in each case, so that a handover of the goods object can be carried out as a first handover operation, and in that the handover device contains a means which can prevent a handover of the parcel.

12. A transfer device according to claim 11, characterized in that the means comprises a controllable holding or fixing device for releasably securing and preventing the removal of a parcel.

13. Transfer device according to one of claims 11 to 12, characterized in that the holding or fixing device can be connected to the reusable container by means of a coupling mechanism, in particular an androgynous coupling mechanism, at a corresponding point of the reusable container for securing.

14. Transfer device according to any one of claims 11 to 12, characterized in that the holding or fixing device can fix the parcel by means of a magnet and/or an electromagnet.

15. A transfer device according to any one of claims 11 to 12, characterized in that the holding or fixing device engages a tab and/or a groove provided therefor on the parcel and secures it.

16. Transfer device according to one of claims 11 to 12, characterized in that the holding or fixing device has a suction gripper.

17. Logistics system for handover of a plurality of parcels, wherein the logistics system is set up so that it can handover parcels of a plurality of shippers to a plurality of recipients, and wherein the logistics system is also set up so that it can carry out at least one processing operation of the parcels using a parcel identification code respectively assigned to the parcels, characterized in that, for at least some of the parcels, in each case at least one goods object contained in the parcel is made available to respective first recipients for removal, so that handovers of the goods objects contained in the parcels in each case are carried out as first handover operations, but a handover of this part of the parcels is prevented during the first handover operations, so that this part of the parcels is not handed over to the recipients of the goods objects.

18. Logistics system according to claim 17, characterized in that a parcel that was not handed over in the first handover operations is used after the first handover operation in each case in at least one further handover operation for a handover of at least one further goods object to a recipient of the further goods object.

19. Logistics system for handover of a plurality of parcels, wherein the logistics system is set up so that it can handover parcels of a plurality of shippers to a plurality of recipients, and wherein the logistics system is further set up so that it can carry out at least one processing operation of the parcels using a parcel identification code respectively assigned to the parcels, in particular according to one of claims 17 or 18, characterized in in that, for at least some of the parcels, in each case at least one goods object located in the parcel is made available to a recipient for removal, so that a handover of the goods object is carried out as the first handover operation, in that at least individual parcels are designed as returnable containers which are provided with individual identifiers, and in that the returnable containers are assigned parcel identification codes as a function of further information.

20. Logistics system according to claim 19, characterized in that a first parcel identification code is assigned to the returnable container marked with the individual identifier until a first handover of a goods object contained therein to a first recipient, and in that a new parcel identification code is assigned to the returnable container provided with the individual identifier after filling with at least one further goods object, in particular in such a way that the returnable container is processed by a logistics system as a further parcel without the returnable containers having to be marked again for further processing operations within the logistics system.
